(19) United States
(12) Patent Application Publication
(10) Pub. No.: US 2012/0330553 A1
(43) Pub. Date: Dec. 27, 2012

(54) METHOD FOR GENERATING A GENERAL ENHANCED OIL RECOVERY AND WATERFLOOD FORECASTING MODEL

(75) Inventors: Alireza Mollaei, Houston, TX (US); Larry W. Lake, Austin, TX (US); Mojdeh Delshad, Austin, TX (US)

(73) Assignee: BOARD OF REGENTS, THE UNIVERSITY OF TEXAS SYSTEM, Austin, TX (US)

(21) Appl. No.: 13/532,494

(22) Filed: Jun. 25, 2012

Related U.S. Application Data
(60) Provisional application No. 61/501,497, filed on Jun. 27, 2011.

(51) Int. Cl. G06F 19/00

(52) U.S. Cl. 702/11

(57) ABSTRACT

In accordance with one or more embodiments of the present disclosure a method for forecasting an advanced recovery process for a reservoir comprises determining a displacement Koval factor associated with a displacement agent associated with an advanced recovery process. The displacement Koval factor is based on heterogeneity of porosity of the reservoir and mobility of the displacement agent. The method further comprises determining a final average oil saturation of the reservoir associated with the advanced recovery process being finished. The method additionally comprises determining an average oil saturation of the reservoir as a function of time for the advanced recovery process based on the displacement Koval factor and the final average oil saturation.

### RELATED APPLICATION

This application claims benefit under 35 U.S.C. §119(e) of U.S. Provisional Application Ser. No. 61/501,497, entitled “METHOD FOR GENERATING A GENERAL ENHANCED OIL RECOVERY AND WATERFLOOD FORECASTING MODEL,” filed Jun. 27, 2011, the entire content of which is incorporated herein by reference.

### TECHNICAL FIELD

The present disclosure relates in general to oil reservoir enhanced oil recovery (EOR) and waterflood performance analysis and, more particularly, to a method for generating a general isothermal enhanced oil recovery and waterflood forecasting model.

### BACKGROUND

Increasing the oil recovery from oil reservoirs using advanced recovery methods (e.g., waterflood and enhanced oil recovery (EOR) methods) has become important to provide the increasing demand of required world energy. Therefore, performance prediction of waterflood and EOR processes and selecting the best recovery process to obtain the maximum possible oil recovery becomes increasingly important. These advanced recovery methods may also be referred to as secondary or tertiary recovery methods.

In some traditional methods numerical simulations may be used to predict recovery performance to select a suitable advanced recovery process for extracting oil from a particular reservoir. However, it is not always possible neither convenient to use numerical simulation for history matching or predicting (forecasting) the reservoir performance under various recovery processes. For example, in advanced recovery screening/forecasting for an asset of reservoirs it may be difficult or even impossible to use numerical simulation for predicting the performance of all of the reservoirs in the asset for several advanced recovery processes. Lack of necessary reservoir data and too much required time can be barriers for history matching and/or predicting the performance of different advanced recovery procedures even for one reservoir.

### SUMMARY

In accordance with one or more embodiments of the present disclosure a method for forecasting an advanced recovery process for a reservoir comprises determining a displacement Koval factor associated with a displacement agent associated with an advanced recovery process. The displacement Koval factor is based on heterogeneity of porosity of the reservoir and mobility of the displacement agent. The method further comprises determining a final average oil saturation of the reservoir associated with the advanced recovery process being finished. The method additionally comprises determining an average oil saturation of the reservoir as a function of time for the advanced recovery process based on the displacement Koval factor and the final average oil saturation.

### BRIEF DESCRIPTION OF THE DRAWINGS

FIG. 1 illustrates an example of an advanced recovery system, in accordance with some embodiments of the present disclosure;

FIG. 2 illustrates a schematic of a segregated flow displacement of oil of a reservoir with heterogeneous porosity, in accordance with some embodiments of the present disclosure;

FIG. 3 illustrates a schematic of a locally segregated flow displacement of oil of a reservoir modeled at a laboratory scale, in accordance with some embodiments of the present disclosure;

FIG. 4a illustrates a storage capacity profile of a reservoir determined based on a general advanced recovery forecasting model, in accordance with some embodiments of the present disclosure;

FIG. 4b illustrates a flow vs. storage (F-C) capacity curve of a reservoir determined in accordance with some embodiments of the present disclosure;

FIG. 4c illustrates a flow vs. time (F*-t_{D}) curve calculated in accordance with some embodiments of the present disclosure;

FIG. 5 illustrates a storage capacity profile of a reservoir having a two-front advanced recovery process, in accordance with some embodiments of the present disclosure;

FIG. 6 illustrates an output of the general advanced recovery forecasting tool, in accordance with some embodiments of the present disclosure;

FIG. 7 illustrates an example schematic of an average oil saturation profile of a reservoir during an advanced recovery process when there is an oil bank, in accordance with some embodiments of the present disclosure;

FIGS. 8a and 8b illustrate examples of predicted data computed for a waterflood recovery process using a general advanced recovery forecasting model of the present disclosure versus actual waterflood recovery data, in accordance with some embodiments of the present disclosure;

FIG. 9 illustrates an example of predicted data computed for a polymer flood using a general advanced recovery forecasting model of the present disclosure versus polymer flood history data, in accordance with some embodiments of the present disclosure;

FIG. 10 illustrates an example of predicted data computed for a surfactant-polymer (SP) flood using a general advanced recovery forecasting model of the present disclosure versus surfactant-polymer flood history data, in accordance with some embodiments of the present disclosure;

FIG. 11 illustrates an example of predicted data computed for an alkaline surfactant-polymer (ASP) flood using a general advanced recovery forecasting model of the present disclosure versus alkaline surfactant-polymer flood history data, in accordance with some embodiments of the present disclosure;

FIG. 12 illustrates an example of predicted data computed for a water-alternating-gas (WAG) flood using a general advanced recovery forecasting model of the present disclosure versus WAG flood history data, in accordance with some embodiments of the present disclosure;

FIG. 13 illustrates a simulated reservoir, in accordance with some embodiments of the present disclosure;

FIG. 14 FIG. 12 illustrates another example of predicted data computed for a water-alternating-gas (WAG) flood using a general advanced recovery forecasting model of the present disclosure versus WAG flood history data, in accordance with some embodiments of the present disclosure;

FIG. 15a shows a correlation describing a chemical (polymer) front Koval factor (K_{C}), in accordance with some embodiments of the present disclosure;

FIG. 15b shows a correlation describing an oil bank front Koval factor (K_{B}) in accordance with some embodiments of the present disclosure;

FIG. 15c shows a correlation describing a final average oil saturation (S_{oF}), in accordance with some embodiments of the present disclosure;

FIG. 16a shows a correlation describing a solvent front Koval factor (K_{S}), in accordance with some embodiments of the present disclosure;

FIG. 16b shows a correlation describing an oil bank front Koval factor (K_{B}) in accordance with some embodiments of the present disclosure;

FIG. 16c shows a correlation describing a final average oil saturation (S_{oF}), in accordance with some embodiments of the present disclosure;

FIG. 17a shows a correlation of a water front Koval factor (K_{W}), in accordance with some embodiments of the present disclosure;

FIG. 17b shows a correlation of a final average oil saturation (S_{oF}), in accordance with some embodiments of the present disclosure; and

FIG. 18 illustrates a flow chart of an example method for forecasting results of an advanced recovery process in accordance with some embodiments of the present disclosure.

### DETAILED DESCRIPTION

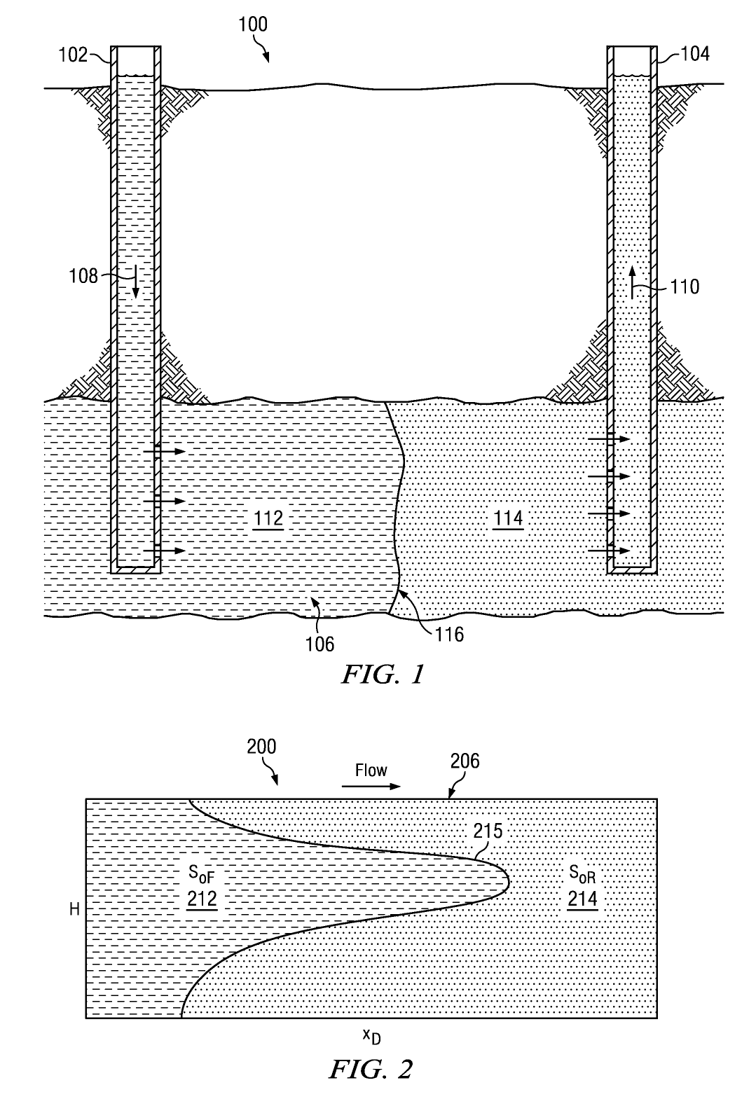

FIG. 1 illustrates an example of an advanced recovery (e.g., waterflooding or enhanced oil recovery (EOR)) system 100 in accordance with some embodiments of the present disclosure. Advanced oil recovery may be used to increase the amount of crude oil that may be extracted from an oil reservoir. Advanced oil recovery may include various methods or processes that may increase the amount of oil extracted by increasing the pressure of the reservoir to force more oil into a producing wellbore. For example, a displacement agent 108 may be injected into a reservoir 106 containing oil 110 via an injection well 102. Displacement agent 108 may increase the pressure of reservoir 106 which may move oil 110 toward a production well 104 via a displacement front 116. Accordingly, oil 110 may be recovered via production well 104. The area of reservoir 106 behind displacement front 116 where the oil 110 has been displaced by the advanced recovery process may be referred to as the swept zone, depicted as swept zone 112 in FIG. 1. Although the area behind displacement front 116 is referred to as a swept zone, it is understood that some areas of swept zone 112 may not have actually been swept by displacement agent 108 because of uneven porosity and such of reservoir 106. However, for simplicity, the areas of reservoir 106 behind displacement front 116 are nonetheless referred to as a swept zone. The area of reservoir 106 in front of displacement front 116 where the oil 110 has yet to be displaced by the advanced recovery process may be referred to as the unswept zone, depicted as unswept zone 114 in FIG. 1.

Displacement agent 108 may comprise any suitable agent for displacing oil 110. For example, in a waterflooding advanced recovery process, displacement agent 108 may comprise water and the pressure of reservoir 106 may be increased by injecting water in reservoir 106. For EOR methods (e.g., a chemical flood, a solvent (gas) flood), the displacement agent 106 may include any suitable gas or chemical (e.g., carbon dioxide, water-alternating-gas (CO2), nitrogen, hydrocarbon gases, polymers, surfactant-polymers, alkaline surfactant polymers, etc.) In the present disclosure, advanced recovery processes may also be referred to as secondary or tertiary recovery processes, as explained in further detail below.

Each advanced recovery process may yield different production results for a particular reservoir 106. Therefore deciding which advanced recovery process may best suit a particular reservoir may increase the efficiency of implementing an advanced recovery process for any given reservoir 106. Different predictive models for each advanced recovery process may exist to determine the increased production of a given reservoir for a particular recovery process. However, because of the differences in each advanced recovery forecasting, such models may have limited applicability in comparing which advanced recovery process may be most suited for use with a given reservoir. This difficulty may arise because it may be difficult or impossible to determine whether differences in production of a reservoir using different advanced recovery processes, as predicted by the separate models, are caused by model differences or the advanced recovery process differences. Therefore, according to some embodiments of the present disclosure, a general advanced recovery forecasting model may be generated that may be used to predict production of a given reservoir for a plurality of advanced recovery processes. For purposes of the present disclosure, reference to a general advanced recovery forecasting (or prediction) model (or tool), may refer to the general model for predicting the recovery performance of isothermal waterflooding and EOR methods.

As detailed below, in accordance with the present disclosure a general advanced recovery forecasting may be used to forecast the average oil saturation of a reservoir as a function of time for a plurality of advanced recovery methods. The average oil saturation may be used to determine other factors including, but not limited to, recovery efficiency, cumulative oil recovery, oil cut, volumetric sweep, and oil rate changes as a function of time for each of the plurality of advanced recovery processes for a given reservoir. Additionally, the general advanced recovery forecasting model may be used to generate the volumetric efficiency change of the given reservoir for each advanced recovery process used. In accordance with some embodiments of the present disclosure, some isothermal advanced recovery processes that may be modeled using the same general advanced recovery forecasting model may include waterfloods (WF), CO2 floods, water-alternating-gas (CO2), surfactant-polymer floods (SP), polymer floods (P), and alkaline surfactant (ASP) floods.

Therefore, the general advanced recovery forecasting model of the present disclosure may be implemented in an estimation tool to predict the performances of various advanced recovery processes for a given reservoir. As such, a comparison between the performances of each simulated advanced recovery process may be made to determine which process may be most suitable for a given reservoir 106. By using the same model for each method, the differences in performance for the different advanced recovery processes may be attributed to the differences in the processes themselves and not the models.

The general advanced recovery forecasting model may be based on one or more assumptions that allow for simulating different advanced recovery processes using the same model. The general advanced recovery forecasting model may assume that isothermal and steady state conditions prevail and that there are no chemical reactions between components in the reservoir. The general advanced recovery forecasting model may also be based on the assumption that displacement zones (e.g., swept zone 112 and unswept zone 114) of oil 110 in reservoir 106, are segregated (that is there is sharp boundary between displacement agent 108 and oil 110) as modeled at the scale found in a laboratory experiment (known as “local segregation”). In a laboratory scale, the porosity of a reservoir 106 may be modeled as being homogenous such that the “local segregation” between a swept zone 112 and an unswept zone 114 is substantially uniform. In contrast, in actual rock formations, the porosity of the reservoir 106 may be heterogeneous such that the segregation between a swept zone 112 and an unswept zone 114 may be distorted. In contrast to the general advanced recovery forecasting model of the present disclosure, standard theories of displacement on this generally do not predict local segregation. However, in practice, local segregation may be the most common displacement type, so the model assumes that it may be true from the start. The general advanced recovery forecasting model may account for deviations from the local segregation by using a modified Koval approach described below.

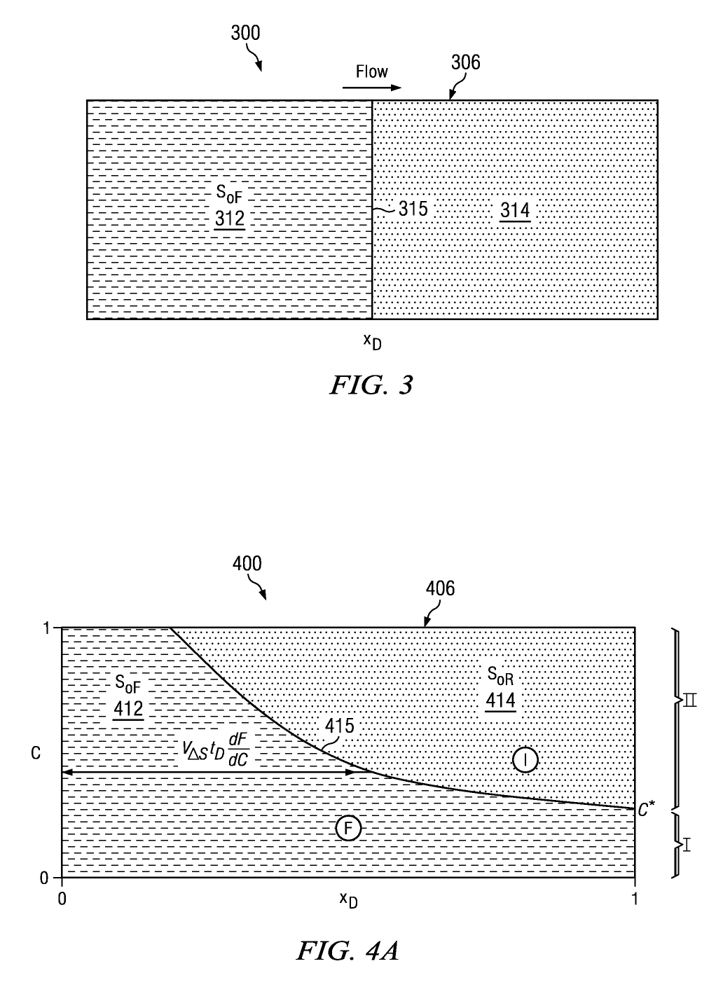

FIG. 2 illustrates a schematic 200 of a segregated flow displacement of oil 210 of a reservoir 206 with heterogeneous porosity, in accordance with some embodiments of the present disclosure. As shown in FIG. 2, a displacement front 215 between a swept zone 212 and unswept zone 214 may be distorted because of differences in the porosity throughout reservoir 206. In contrast, FIG. 3 illustrates a schematic 300 of a locally segregated flow displacement of oil 310 of a reservoir 306 modeled at a laboratory scale. As shown in FIG. 3, a displacement front 315 between a swept zone 312 and an unswept zone 314 may be substantially uniform because of substantial uniformity in the porosity of reservoir 306.

By using the local segregation assumption and by using a Koval factor, the isothermal advanced recovery processes considered may behave alike with respect to local behavior. The general advanced recovery forecasting model may accordingly determine changes in the average oil saturation of a reservoir as a function of time for different advanced recovery processes. Accordingly, the different advanced recovery process results determined by the general advanced recovery forecasting model may differ only in the magnitude of the oil saturation changes of a reservoir between different zones of the reservoir (e.g., a swept zone and an unswept zone), such that different advanced recovery processes may be compared. “Saturation” may refer to the ratio of one phase volume (for example oil or water) to the reservoir pore volume (Sᵢ=Vᵢ/PV, where i=oil, water, etc., V=Volume, PV=total reservoir pore volume). Additionally, by assuming local segregation, it may be unnecessary to know relative permeability data of a reservoir over the complete oil saturation range. All that may be required are the endpoint oil saturation and perhaps a single point on a fractional flow curve, as detailed below.

In segregated flow, the oil saturation of a reservoir behind a displacement front (e.g., a water flood, a gas flood, an SP flood, an ASP flood, etc.) may be reduced to a final oil saturation (S_{oF}) as more oil is displaced by the displacement front. As disclosed in further detail below, the general advanced recovery model of the present disclosure may determine the final average oil saturation of a reservoir after an advanced recovery process is finished and may use this value for S_{oF} to indicate the average oil saturation of the reservoir behind a displacement front. As mentioned above, some portions of a reservoir behind a displacement front may be missed by the displacement front because of inconsistencies within a reservoir. Accordingly, S_{oF} may account for portions of reservoir 106 that were both actually swept by a displacement front and those that were missed by the displacement front during the advanced recovery process. For example, in FIG. 2, the oil saturation of reservoir 206 in swept zone 212 behind displacement front 215 may be given a value based on the final average oil saturation (S_{oF}) determined for reservoir 206. As disclosed in further detail below, the general advanced recovery forecasting model of the present disclosure may use the final average oil saturation (S_{oF}) of a reservoir to determine the average oil saturation of the reservoir as a function of time.

As discussed in detail below, S_{oF} may be determined using a history matching approach by iteratively predicting results of an advanced recovery process that has already occurred using the general advanced recovery forecasting model of the present disclosure. The predicted results may be compared with the actual historical results using an error detection algorithm. If the error is not within a specified range, S_{oF} may be adjusted until the error is within the specified range. Accordingly, the determined S_{oF} may be used for predicting the results of a similar advanced recovery process in a similar reservoir to those of the historical data. In another embodiment, as discussed in greater detail below, S_{oF} may be determined by correlating S_{oF} with a variety of known parameters associated with the reservoir extracted from reservoir data such as the displacement agent mobility ratio, heterogeneity measurements from the reservoir and heterogeneity arrangements in the reservoir.

The general advanced recovery forecasting model of the present disclosure may also use the remaining oil saturation (S_{oR}) of a reservoir to determine the average oil saturation of the reservoir as a function of time, as discussed further below. S_{oR} refers to the remaining oil saturation of the reservoir at the start of the advanced recovery process after conventional recovery processes have been used. S_{oR} may be determined based on data collected from the reservoir after a conventional recovery process has been used. The oil saturation of the reservoir in the unswept zone may be given the value of the remaining oil saturation of the reservoir (S_{oR}). For example, in FIG. 2, the oil saturation of reservoir 206 in unswept zone 214 in front of displacement front 215 may be given value of the remaining oil saturation (S_{oR}) based on data gathered from reservoir 206. By using these simplifying assumptions, results may be obtained that agree well with field results and numerical simulation.

Depending on the advanced recovery process, there may be another constant oil saturation region of a reservoir between a swept zone and an unswept zone that may be called an oil bank zone with oil saturation S_{oB} (not expressly shown in FIGS. 2 and 3, but illustrated in FIG. 5) that has a constant oil saturation different from (usually higher than) S_{oR}. The oil bank saturation region usually is created in EOR processes and is the result of the miscibility in miscible (solvent) floods or banking or an enhanced saturation of the oil in the region as the oil “banks” (because of increasing of sweep efficiency) in the reservoir. In predicting the average oil saturation as a function of time, the general advanced recovery forecasting model may also take into consideration S_{oB}. S_{oB} may be determined based on a fractional flow curve as is known in the art and described in the textbook titled: “Enhanced Oil Recovery” by Larry W. Lake, Prentice Hall, Inc., Upper Saddle River, N.J., 1996 (ISBN 0132816016) and the PhD dissertation titled: “Forecasting of Isothermal EOR and Waterflooding Processes” by Alireza Mollaei of the University of Texas at Austin, 2011 (found at http://repositories.lib.utexas.edu/bitstream/handle/2152/ETD-UT-2011-12-4671/MOLLAEI-DISSERTATION.pdf?sequence=1). In alternative embodiments (e.g., when not enough information is given to generate a fractional flow curve), S_{oB} may be determined using a history matching approach by iteratively predicting results using the general advanced recovery forecasting model of the present disclosure of an advanced recovery process that has already occurred, similarly to as described above with respect to S_{oF}.

The general advanced recovery forecasting model forecasting tool may also determine a Koval factor for a displacement agent (and a Koval factor for an oil bank where applicable), as discussed in greater detail below. The Koval factor for a displacement agent may be an indicator of the effective mobility ratio of the displacement agent as a function of the mobility of the displacement agent itself and the heterogeneity of the reservoir. For example, a water displacement agent may have a Koval factor based on the mobility of water and the heterogeneity of the reservoir. A gas displacement agent for the same reservoir may have a different Koval factor than that of the water based on the difference in the mobility of the gas. A Koval factor may also be determined for the oil of an oil bank based on the mobility of the oil and the heterogeneity of the reservoir.

As discussed in detail below, the Koval factor may be determined using a history matching approach by iteratively predicting results of an advanced recovery process that has already occurred using the general advanced recovery forecasting model of the present disclosure, similarly to as described above with respect to S_{oF}. In another embodiment, as discussed in greater detail below, the Koval factor may be determined similarly to S_{oF} by correlating the Koval factor with a variety of known parameters associated with the reservoir extracted from reservoir data such as the displacement agent mobility ratio, heterogeneity measurements from the reservoir and heterogeneity arrangements in the reservoir.

Accordingly, the general advanced recovery forecasting model of the present disclosure may determine the storage capacity profile of a reservoir (expressed as the average oil saturation of the reservoir as a function of time) for any one of a plurality of advanced recovery methods based on the final average oil saturation (S_{oF}), the remaining oil saturation (S_{oR}), the oil saturation of an oil bank (S_{oB}) (where applicable), a Koval factor for a displacement agent, and a Koval factor for an oil bank (where applicable), as disclosed in detail below. The general advanced recovery forecasting model may model changes in the average oil saturation of a reservoir as a function of time as a displacement agent propagates through the reservoir. As described in detail below, the average oil saturation as a function of time may be used to determine other oil production factors such as, for example, recovery efficiency, cumulative oil recovery, oil cut, volumetric sweep, and oil rate changes. Accordingly, the general advanced recovery forecasting model may be used to predict the production of different advanced recovery processes for a given reservoir to determine which may yield the best results for the reservoir.

For purposes of the present disclosure, the following nomenclature may be used in the descriptions:

BHP=Bottom hole pressure, psia
C=Storage capacity, fraction
E_{D}=Displacement efficiency, fraction
E_{V}=Volumetric sweep efficiency, fraction
E_{R}=Recovery efficiency, fraction
F=Flow capacity, dimensionless
fₒ=Oil cut, dimensionless
H=Total thickness, ft
h=Layer thickness, ft
K=Koval factor, dimensionless
k=permeability, and
M^{o}=End point mobility ratio, dimensionless
MMP=Minimum miscibility pressure, psia
Nₚ=Oil production, STB
OOIP=Original oil in place, STB
P=Pressure, psia
R²=Correlation Coefficient, dimensionless
Sₒᵣ=Residual oil saturation after EOR, fraction
S_{oR}=Remaining oil saturation at start of EOR or Waterflood, fraction
t_{D}=Dimensionless time, dimensionless
V_{DP}=Dykstra-Parsons coefficient dimensionless
Vₚ=Pore volume, dimensionless
v=Specific velocity, dimensionless
W_{R}=WAG ratio, dimensionless
xₓ: Dimensionless distance, dimensionless

### Latin Symbols

φ=Porosity, fraction
λ=Geostatistical dimensionless correlation length, dimensionless

### μ=Viscosity, cp

### Subscripts and Superscripts

B=Oil bank
BT=Break through
C=Chemical or displacing agent

### F=Final

f=front

### I=Initial

i=original

### J=Injection

o=Oil

### S=Solvent

### SW=Sweep-out

w=Water

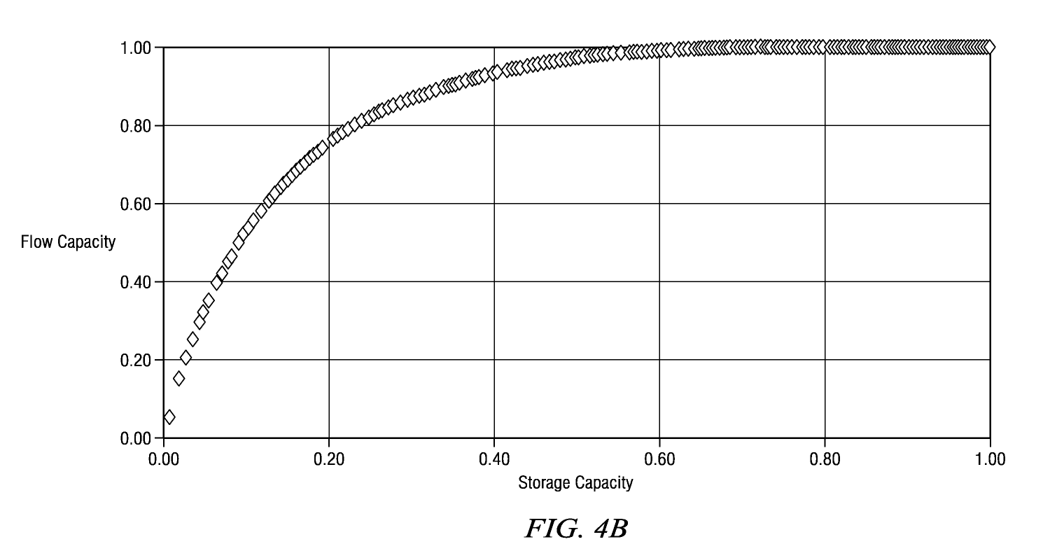

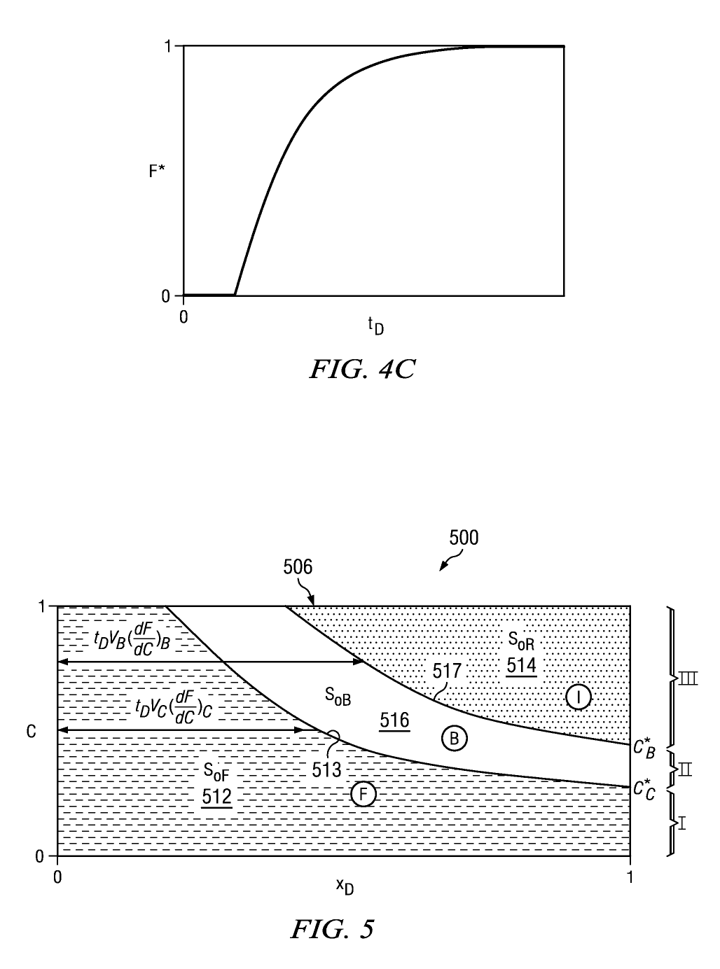

FIG. 4a illustrates a storage capacity profile 400 of a reservoir 406 determined based on a general advanced recovery forecasting model, according to an example of the present disclosure. As discussed above, S_{oF} of FIG. 4a may refer to the final average oil saturation in swept zone 412 of reservoir 406 and S_{oR} may refer to the remaining oil saturation at the start of advanced recovery project. The storage capacity profiles of secondary and tertiary recovery may be differentiated based on a number of constant oil saturation regions that occur during the flooding of a reservoir. For instance, in a secondary recovery method depicted in FIG. 4a (e.g., waterflooding) there may be two saturation regions (e.g., swept zone 412 with a saturation of S_{oF} and unswept zone 414 with a saturation of S_{oR}), which may be referred to as a “one-front displacement” case because there is one displacement front between the swept zone 412 and unswept zone 414. For tertiary recovery methods, such as chemical and gas flooding, an oil bank region may be created and there may be three saturation regions as shown as S_{oF}, S_{oB} and S_{oR} in FIG. 5, described further below. Therefore, in tertiary recovery methods, there may be two displacement fronts between the swept zone and the unswept zone, which may be referred to as a “two-front displacement” case. The average oil saturation of reservoir 406 as a function of time for a given advanced recovery process may be predicted using the general advanced recovery forecasting model as described below.

To determine the oil saturation of reservoir 406 as a function of time, a fractional flow vs. storage (F-C) capacity curve may be generated for reservoir 406. The fraction of injected fluid flowing into a given storage capacity of reservoir 406 (or given layer in case of layered reservoir) is proportional to the permeability of reservoir 406 (k) over the porosity (φ) of reservoir 406 (k/φ) at that location and may equal to

$${t}_{D} \frac{d F}{d C} ,$$

where t_{D} is the total pore volume of injected fluid and

$$\frac{d F}{d C}$$

is derivative of flow capacity (F) to storage capacity (C).

The flow capacity (Fₙ) and storage capacity (Cₙ) of reservoir 406 may be described by the equations listed below:

$${F}_{n} = \frac{{\sum }_{i = 1}^{i = n} {( kh )}_{i}}{{\sum }_{i = 1}^{i = {N}_{L}} {( kh )}_{i}}$$

$${C}_{n} = \frac{{\sum }_{i = 1}^{i = n} {( φ h )}_{i}}{{\sum }_{i = 1}^{i = {N}_{L}} {( φ h )}_{i}}$$

In the above equations:

kᵢ is the permeability of the ith layer,

φᵢ is the porosity of the ith layer,

hᵢ is the thickness of the ith layer,

n is the layer in which the displacing agent is just breaking through at the cross-section, and

N_{L} is the total number of layers.

FIG. 4b illustrates a flow vs. storage (F-C) capacity curve of a reservoir determined according to an example of the present disclosure. The curve may be calculated from core data of reservoir 406 or from correlations of permeability from log data of reservoirs similar to reservoir 406. In the present example, the permeabilities are arranged in order of decreasing permeability/porosity. The F-C curve may be a cumulative distribution function of the velocities of fluids in a reservoir and may apply to any reservoir, uniformly layered or not. If the reservoir is uniformly layered, the F-C curve may be directly related to sweep of the reservoir by the advanced recovery process.

Returning to FIG. 4a, the location of displacement front 415 may be determined based on the velocity of displacement front 415 and the amount of time elapsed since initiation of the advanced recovery process as shown by Equation 1:

$${x}_{{D}_{f}} = \{ \begin{matrix}1 & 0 < C < {C}^{*} \\ {v}_{Δ S} {t}_{D} \frac{d F}{d C} & {C}^{*} < C < 1\end{matrix} \qquad ( 1 )$$

where v_{ΔS} is the injected (displacing) fluid dimensionless velocity (specific velocity; normalized by the bulk fluid interstitial velocity) which is constant and is found from fractional flow analysis (construction) and C*=C(x_{D}_{_{f}}=1; production point).

As mentioned above, the general advanced recovery forecasting model may be used to predict the results of different advanced recovery processes based on a the oil saturation of reservoir 406 in swept zone 412 and unswept zone 414 to obtain an average oil saturation. As displacement front 415 propagates through reservoir 406, the sizes of swept zone 412 and unswept zone 414 changes such that the average oil saturation changes with time. Accordingly, the advanced recovery forecasting model may predict the average oil saturation of reservoir 406 as a function of time as displacement front 415 moves through reservoir 406.

Oil saturation at a given location C at a given time (t_{D}) (local oil saturation), Sₒ|_{C}, may be based on whether the given C is associated with a layer that includes at least one of the swept zone 412 and the unswept zone 414. For example, layer I in FIG. 4a may include only swept zone 412 and layer II in FIG. 4a may include swept zone 412 and unswept zone 414. As shown in Equation 2 below, Sₒ|_{C} may change with time as displacement front 415 propagates through reservoir 406. Sₒ|_{C} may be expressed by Equation 2:

$$\{ \begin{matrix}{S}_{o} {\vert}_{C} = {t}_{D} {v}_{Δ S} ( \frac{d F}{d C} ) {S}_{oF} + [ 1 - {t}_{D} {v}_{Δ S} ( \frac{d F}{d C} ) ] {S}_{oR} , & II \\ {S}_{o} {\vert}_{C} = {S}_{oF} , & I\end{matrix} \qquad ( 2 )$$

where I and II are different regions on C-X_{D} plot depicted on FIG. 4a, as described above. Note that

Integrating the local oil saturation, Sₒ|_{C} with respect to C yields the average oil saturation of reservoir 406 at a given time:

$$\begin{matrix}{\overline{S}}_{o} = {\int }_{C = 0}^{C = 1} {S}_{o} {\vert}_{C} d C \\ = {\int }_{C = 0}^{C = {C}^{*}} {S}_{o} {\vert}_{C} d C + {\int }_{C = {C}^{*}}^{C = 1} {S}_{o} {\vert}_{C} d C \\ = I + II\end{matrix} \qquad ( 3 )$$

By integrating the step change in solving the ordinary differential equation/s (ODE/s) of the local oil saturation described in Equation 2, it is possible to solve directly for average oil saturation of the reservoir, S̅ₒ, by solving the obtained integral equation instead of an ODE (or a set of ODEs for EOR cases) at a given time. Integral equations are usually easier to solve than differential equations. In addition, upon solving the integral equation, the up-scaling problem of the fluid flow may be solved, which otherwise could be a very complicated problem by itself.

Substituting the terms in Equation 3 from Equation 2, one can write:

$${\overline{S}}_{o} = {S}_{oF} {C}^{*} + {\int }_{C = {C}^{*}}^{C = 1} [ ( {S}_{oF} - {S}_{oR} ) {v}_{Δ S} {t}_{D} \frac{d F}{d C} + {S}_{oR} ] d C \qquad ( 4 )$$

Knowing that F(C=0)=0 and F(C=1)=1:

S̅ₒ=S_{oR}−ΔSₒ[C*+v_{ΔS}t_{D}(1−F*)], (5)

### ΔSₒ=S_{oR}−S_{oF} and F*=F(C*)

at C*=1 [symbol] F*=1 [symbol] S̅ₒ=S_{oF}

From the above equation, it may be determined that:

S̅ₒ= S̅ₒ(C*)= S̅ₒ(C*(t_{D}))= S̅ₒ(t_{D})

Which may show that S̅ₒ is a function of time (t_{D}) as is C* (detailed further below). Equivalent to Buckley-Leverett equation, we can write:

$$( \frac{d F}{d C} ) {\vert}_{{C}^{*}} = \frac{1}{{v}_{Δ S} {t}_{D}} \qquad ( 6 )$$

Up to equation 6, the formulation may be general but it may be advantageous to take advantage of an equation with only one parameter to describe the F-C function as F=F(C). Reservoir 406 may be heterogeneously permeable such that a uniform propagation of a displacement agent and thus, uniform displacement of oil by the displacement agent may not occur. Accordingly, a Koval fractional flux model may be used to describe the propagation of the displacement agent (F-C function) in a heterogeneous reservoir because of the Koval fractional flux model's abilities and wide application even in situations where reservoir 406 may include a very heterogeneous permeable media.

using a Koval F-C model:

$$F = \frac{1}{1 + \frac{1 - C}{KC}} : Koval fractional flux model \qquad ( 7 )$$

where K is a Koval factor that is a function of both mobility ratio of the displacement agent and reservoir heterogeneity. As mentioned above, K may be called the Effective Mobility Ratio since, as disclosed further below, it is able to effectively capture the effects of reservoir heterogeneity and mobility of the displacement agent and oil even for high reservoir heterogeneity. In contrast, the conventional mobility ratio defined in literature as a ratio of displacing to displaced fluid mobility does not include the effects of reservoir heterogeneity.

The derivative of F with respect C is calculated to give the specific velocity of displacement front 415, which may be used to determine the location of displacement front 415 from the injection well associated with the advanced recovery process. Equation 8 below illustrates the calculation of the derivative of F with respect to C:

$$\frac{d F}{d C} = \frac{K}{{( 1 + ( K - 1 ) C )}^{2}} \qquad ( 8 )$$

### Substituting in Equation 6:

$$\frac{1}{{v}_{Δ S} {t}_{D}} = \frac{K}{{( 1 + ( K - 1 ) C )}^{2}} \qquad ( 9 )$$

solving Equation 9 for C results in C=C*:

$$\begin{matrix}{C}^{*} = \frac{\sqrt{{v}_{Δ S} {t}_{D} K} - 1}{K - 1} & ( 10 ) \\ and & \\ {F}^{*} = F ( {C}^{*} ) = \frac{1}{1 + \frac{1 - {C}^{*}}{{KC}^{*}}} = \frac{K [ {( {v}_{Δ S} {t}_{D} K )}^{1 / 2} - 1 ]}{{( {v}_{Δ S} {t}_{D} K )}^{1 / 2} ( K - 1 )} & ( 11 )\end{matrix}$$

where F* and C* are flow capacity and storage capacity at x_{D}=1.
Equations 12 and 13 describe F* and C* as discontinuous functions of time (t_{D}).

$$\begin{matrix}{C}^{*} = \{ \begin{matrix}0 & {t}_{D} \leq {t}_{{D}_{BT}} \\ \frac{\sqrt{{v}_{Δ S} {t}_{D} K} - 1}{K - 1} & {t}_{{D}_{BT}} < {t}_{D} < {t}_{{D}_{SW}} \\ 1 & {t}_{{D}_{SW}} \leq {t}_{D}\end{matrix} & ( 12 ) \\ {F}^{*} = \{ \begin{matrix}0 & {t}_{D} \leq {t}_{{D}_{BT}} \\ \frac{K [ {( {v}_{Δ S} {t}_{D} K )}^{1 / 2} - 1 ]}{{( {v}_{Δ S} {t}_{D} K )}^{1 / 2} ( K - 1 )} & {t}_{{D}_{BT}} < {t}_{D} < {t}_{{D}_{SW}} \\ 1 & {t}_{{D}_{SW}} \leq {t}_{D}\end{matrix} & ( 13 ) \\ where \text{:} & \\ \{ \begin{matrix}{t}_{{D}_{BT}} is the break \text{-} through time = \frac{1}{{v}_{Δ S} K} \\ {t}_{{D}_{SW}} is the sweep out time = \frac{K}{{v}_{Δ S}}\end{matrix} & ( 14 )\end{matrix}$$

FIG. 4c illustrates a flow vs. time (F*-t_{D}) curve calculated based on equations 8-13 above according to an example of the present disclosure.

The above description of determining average oil saturation of reservoir 406 as a function of time and the associated Koval factors is described in the context of a secondary or one-front advanced recovery process (e.g., waterflooding). However, similar steps and operations may be performed for tertiary (two-front displacement) advanced recovery processes also (e.g., EOR processes).

FIG. 5 illustrates a storage capacity profile 500 of a reservoir 506 having a two-front advanced recovery process (e.g., chemical EOR or solvent (gas) flooding), in accordance with an example of the present disclosure. Reservoir 506 may include a swept zone 512 (F), an oil bank zone 516 (B), and an unswept zone 514 (I). Swept zone 512 and oil bank zone 516 may be segregated by a displacement agent front 515. Oil bank zone 516 and unswept zone 514 may be segregated by an oil bank front 517. Each of oil bank front 517 and displacement agent front 515 may be described by separate F-C curves as they may have different velocities (calculated from fractional flow construction). Accordingly, the general advanced recovery forecasting model may determine a measure of the heterogeneity of swept zone 512 using a first Koval factor for the displacement agent and may determine a measure of the heterogeneity of oil bank zone 516 using a second Koval factor for the oil within oil bank zone 516, as described below. Further, the general advanced recovery forecasting model may determine an average oil saturation as a function of time based on the Koval factors and the different oil saturations of swept zone 512, oil bank zone 516 and unswept zone 514, as described below.

Similarly to as described above, oil saturation at a given location C at a given time (local oil saturation), Sₒ|_{C}, may be based on whether the given C is located in a layer that includes at least one of the swept zone 512 (F), oil bank zone 516 (B) and unswept zone 514 (I). For example, layer I in FIG. 5 may include only swept zone 412, layer II in FIG. 5 may include swept zone 512 and oil bank zone 516, and layer III in FIG. 5 may include swept zone 512, oil bank zone 516, and unswept zone 514. The local oil saturation (Sₒ|_{C}) at a given storage capacity layer of reservoir 506 may be expressed by Equation 15:

$$\{ \begin{matrix}{S}_{o} {\vert}_{C} = \overbrace{{t}_{D} {{v}_{C} ( \frac{d F}{d C} )}_{C}}^{F} {S}_{oF} + \overbrace{{t}_{D} [ {{v}_{B} ( \frac{d F}{d C} )}_{B} - {{v}_{C} ( \frac{d F}{d C} )}_{C} ]}^{B} {S}_{oB} + \overbrace{[ 1 - {t}_{D} {{v}_{B} ( \frac{d F}{d C} )}_{B} ]}^{I} {S}_{oR} , & III \\ {S}_{o} {\vert}_{C} = {t}_{D} {{v}_{C} ( \frac{d F}{d C} )}_{C} {S}_{oF} + [ 1 - {t}_{D} {{v}_{C} ( \frac{d F}{d C} )}_{C} ] {S}_{oB} , & II \\ {S}_{o} {\vert}_{C} = {S}_{oF} , & I\end{matrix} \qquad ( 15 )$$

where subscripts B and C stand for displacement agent and oil bank respectively and Sₒ|_{C} is local oil saturation at a given C at a given time (storage capacity).

$${( \frac{d F}{d C} )}_{C} and {( \frac{d F}{d C} )}_{B}$$

are derivatives of displacement agent and oil bank flow capacities with respect to C and represent the respective velocities of the displacement front 515 and oil bank front 517, respectively. The velocities of displacement front 515 and oil bank front 517 may vary depending on the mobility of the displacement agent and oil in oil bank zone 516, as well as the porosity and heterogeneity of the porosity of reservoir 506. The mobility of displacement front 517 and oil bank front 517 may be defined by using the Koval factors associated with the displacement agent of swept zone 512 (K_{C}) and the oil of oil bank zone 516 (K_{B}) as described below:

$${F}_{C} = F ( K = {K}_{C} ) = \frac{1}{1 + \frac{1 - C}{{K}_{C} C}} , \\ {F}_{B} = F ( K = {K}_{B} ) = \frac{1}{1 + \frac{1 - C}{{K}_{B} C}} \qquad ( 16 )$$

C_{C}* and C_{B}* for t_{D} greater than break through time are defined as:

$${C}_{C}^{*} = \frac{\sqrt{{v}_{C} {t}_{D} {K}_{C}} - 1}{{K}_{C} - 1} , {C}_{B}^{*} = \frac{\sqrt{{v}_{B} {t}_{D} {K}_{B}} - 1}{{K}_{B} - 1} \qquad ( 17 )$$

Equation 15 is a set of ODEs and may be solved with the same procedure as for one-front displacement (secondary recovery) processes such as that described above with respect to FIGS. 4a-4c. The solution method includes converting the set of ODEs to integral equations and solving for average oil saturation as function of time, S̅ₒ(t_{D}).

The problem may also be considered in different key times as defined below:

$$\{ \begin{matrix}{t}_{{D}_{BT}}^{B} = \frac{1}{{K}_{B} {v}_{B}} , Oil Bank Breakthrough \\ {t}_{{D}_{BT}}^{C} = \frac{1}{{K}_{C} {v}_{C}} , Displacement agent Breakthrough \\ {t}_{{D}_{SW}}^{B} = \frac{{K}_{B}}{{v}_{B}} , Oil Bank Sweep out \\ {t}_{{D}_{SW}}^{C} = \frac{{K}_{C}}{{v}_{C}} , Displacement agent Sweep out\end{matrix} \qquad ( 18 )$$

1) For t_{D}≦t_{D}_{_{BT}}^{B} (C_{B}*=0, C_{C}*=0)

$${\overline{S}}_{o} = {\int }_{C = 0}^{C = 1} {S}_{o} d C = {\int }_{C = 0}^{C = {C}_{C}^{*}} {S}_{o} d C + {\int }_{C = {C}_{C}^{*}}^{C = {C}_{B}^{*}} {S}_{o} d C + {\int }_{C = {C}_{B}^{*}}^{C = 1} {S}_{o} d C$$

$${C}_{B}^{*} = 0 \& {C}_{C}^{*} = 0 ⇒ {\overline{S}}_{o} = {\int }_{C = 0}^{C = 1} {S}_{o} d {C}_{B} = III$$

$$\begin{matrix}{\overline{S}}_{o} = {\int }_{C = 0}^{C = 1} {S}_{o} d C \\ = {t}_{D} {v}_{C} {S}_{oF} {\int }_{C = 0}^{C = 1} {( \frac{d F}{d C} )}_{C} d C + \\ {t}_{D} ( {v}_{B} - {v}_{C} ) {S}_{oB} {\int }_{C = 0}^{C = 1} {( \frac{d F}{d C} )}_{B} d C - \\ {t}_{D} {v}_{B} {S}_{oR} {\int }_{C = 0}^{C = 1} {( \frac{d F}{d C} )}_{B} d C + {S}_{oR}\end{matrix}$$

As determined above:

$${\int }_{C = 0}^{C = 1} ( \frac{d F}{d C} ) d C = 1$$

### Therefore:

$$\begin{matrix}{\overline{S}}_{o} = {t}_{D} {v}_{C} {S}_{oF} + {t}_{D} ( {v}_{B} - {v}_{C} ) {S}_{oB} + ( 1 - {t}_{D} {v}_{B} ) {S}_{oR} \\ = [ {v}_{C} ( {S}_{oF} - {S}_{oB} ) + {v}_{B} ( {S}_{oB} - {S}_{oR} ) ] {t}_{D} + {S}_{oR}\end{matrix} \qquad ( 19 )$$

that is a linear function of t_{D} ( S̅ₒ=at_{D}+b)
2) For t_{D}_{_{BT}}^{B}≦t_{D}≦t_{D}_{_{BT}}^{C} (0≦C_{B}*≦1, C_{C}*=0)

$${\overline{S}}_{o} = {\int }_{C = 0}^{C = 1} {S}_{o} d C = {\int }_{C = 0}^{C = {C}_{C}^{*}} {S}_{o} d C + {\int }_{C = {C}_{C}^{*}}^{C = {C}_{B}^{*}} {S}_{o} d C + {\int }_{C = {C}_{B}^{*}}^{C = 1} {S}_{o} d C$$

$${C}_{C}^{*} = 0 ⇒ {S}_{o} = {\int }_{C = 0}^{C = {C}_{B}^{*}} {S}_{o} d C + {\int }_{C = {C}_{B}^{*}}^{C = 1} {S}_{o} d C = II + III$$

$${\overline{S}}_{o} = {\int }_{C = 0}^{C = {C}_{B}^{*}} [ {t}_{D} {v}_{C} {{S}_{oF} ( \frac{d F}{d C} )}_{C} + [ 1 - {t}_{D} {{v}_{C} ( \frac{d F}{d C} )}_{C} ] {S}_{oB} ] d C + {\int }_{C = {C}_{B}^{*}}^{C = 1} [ {t}_{D} {v}_{C} {{S}_{oF} ( \frac{d F}{d C} )}_{C} + {t}_{D} [ {{v}_{B} ( \frac{d F}{d C} )}_{B} - {{v}_{C} ( \frac{d F}{d C} )}_{C} ] {S}_{oB} ] d C$$

$${\overline{S}}_{o} = {S}_{ob} {C}_{B}^{*} + {t}_{D} {v}_{C} ( {S}_{oF} - {S}_{oB} ) {F}_{{C}_{B}}^{*} + {S}_{oR} ( 1 - {C}_{B}^{*} ) + {t}_{D} {v}_{C} ( 1 - {F}_{{C}_{B}}^{*} ) {S}_{oF} + {t}_{D} [ {v}_{B} ( 1 - {F}_{{B}_{B}}^{*} ) - {v}_{C} ( 1 - {F}_{{C}_{B}}^{*} ) ] {S}_{oB} - {t}_{D} {v}_{B} ( 1 - {F}_{{C}_{B}}^{*} ) {S}_{oR}$$

$${F}_{{C}_{C}}^{*} = {F}_{C} ( C = {C}_{C}^{*} ) , {F}_{{C}_{B}}^{*} = {F}_{C} ( C = {C}_{B}^{*} ) , {F}_{{B}_{B}}^{*} = {F}_{B} ( C = {C}_{B}^{*} )$$

3) For t_{D}_{_{BT}}^{C}≦t_{D}≦t_{D}_{_{SW}}^{B} 0≦C_{B}*≦1, 0≦C_{C}*≦1

$${\overline{S}}_{o} = {\int }_{C = 0}^{C = 1} {S}_{o} d C = {\int }_{C = 0}^{C = {C}_{C}^{*}} {S}_{o} d C = {\int }_{C = {C}_{C}^{*}}^{C = {C}_{B}^{*}} {S}_{o} d C + {\int }_{C = {C}_{C}^{*}}^{C = 1} {S}_{o} d C = I + II + III \\ {\overline{S}}_{o} = {S}_{oF} {C}_{C}^{*} + {S}_{oB} ( {C}_{B}^{*} - {C}_{C}^{*} ) + {t}_{D} {v}_{C} ( {F}_{{C}_{B}}^{*} - {F}_{{C}_{C}}^{*} ) ( {S}_{oF} - {S}_{oB} ) + {S}_{oR} ( 1 - {C}_{B}^{*} ) + {t}_{D} {v}_{C} ( 1 - {F}_{{C}_{B}}^{*} ) {S}_{oF} + {t}_{D} [ {v}_{B} ( 1 - {F}_{{B}_{B}}^{*} ) - {v}_{C} ( 1 - {F}_{{C}_{B}}^{*} ) ] {S}_{oB} - {t}_{D} {v}_{B} ( 1 - {F}_{{B}_{B}}^{*} ) {S}_{oR} \qquad ( 21 )$$

4) For t_{D}_{_{SW}}^{B}≦t_{D}≦t_{D}_{_{SW}}^{C} C_{B}*=1, 0≦C_{C}*≦1

$${\overline{S}}_{o} = {\int }_{C = 0}^{C = 1} {S}_{o} d C = {\int }_{C = 0}^{C = {C}_{C}^{*}} {S}_{o} d C + {\int }_{C = {C}_{C}^{*}}^{C = 1} {S}_{o} d C = I + II \\ {\overline{S}}_{o} = {S}_{oF} {C}_{C}^{*} + {S}_{oB} ( {C}_{B}^{*} - {C}_{C}^{*} ) + {t}_{D} {v}_{C} ( {F}_{{C}_{B}}^{*} - {F}_{{C}_{C}}^{*} ) ( {S}_{oF} - {S}_{oB} ) \qquad ( 22 )$$

5) For t_{D}_{_{SW}}^{C}≦t_{D} C_{B}*=1, C_{C}*=1

$${\overline{S}}_{o} = {\int }_{C = 0}^{C = 1} {S}_{o} d C = {\int }_{C = 0}^{C = 1} {S}_{o} d C = I \\ {\overline{S}}_{o} = {S}_{oF} \qquad ( 23 )$$

The above equations express average oil saturation ( S̅ₒ) as a function of time (t_{D}).

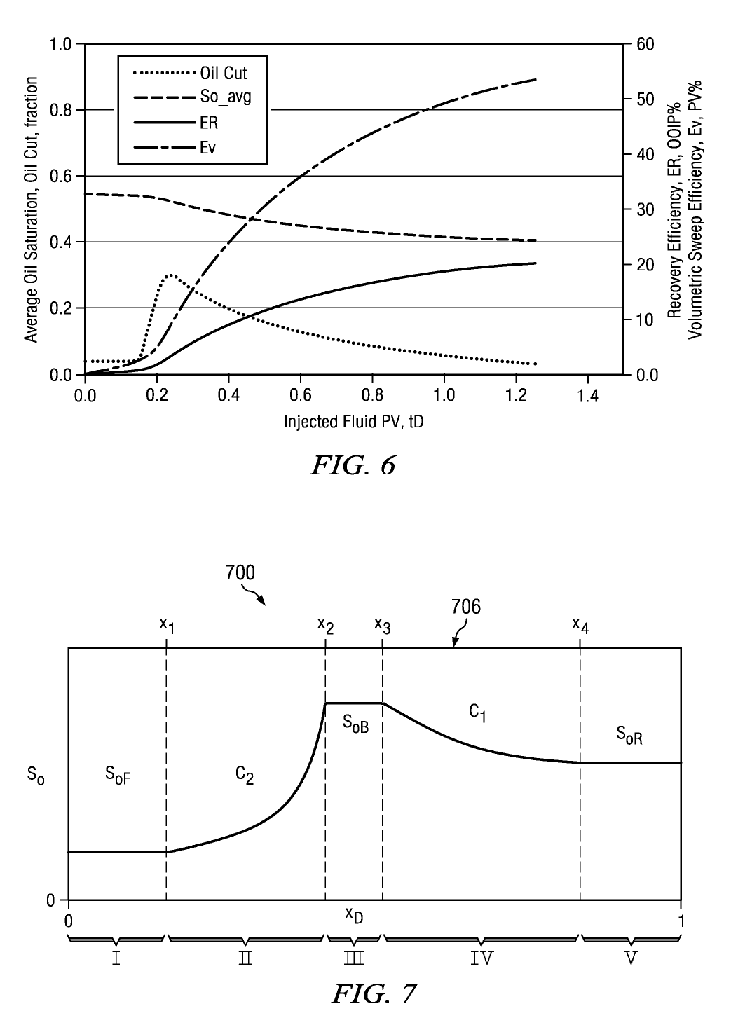

FIG. 6 illustrates an output of the general advanced recovery forecasting tool, according to an example of the present disclosure. In FIG. 6 the term “Oil Cut” refers to an oil production rate/total production rate, “E_{R}” refers to oil recovery efficiency; fraction of original oil of the reservoir that has been produced, “Eᵥ” refers to volumetric efficiency; fraction of total pore volume of the reservoir that has been swept by displacement agent and “So_avg” refers to average oil saturation at a given time.

The above description illustrates a complex mathematical model for forecasting advanced recovery process production of a reservoir 506. However, a more heuristic approach may be used to describe the oil saturation of reservoir 506 as a step function which starts from the final saturation (S_{oF}) of swept zone 512 at the point of injection of displacement agent and where the step function propagates with time toward a production point (e.g., a production well) (with saturation of unswept zone 514, oil bank zone 516, or swept zone 512 (S_{oR}, S_{oB}, or S_{oF}, respectively) with a combination of waves and shocks as expressed in the following equation:

Sₒ(x_{D},t_{D})=S_{oR}+(S_{oB}−S_{oI})C₁(x_{D},t_{D})+(S_{oF}−S_{oB})C₂(x_{D},t_{D}) (24)

where C(x_{D},t_{D}) works as a transition function here that was calculated in previous approach as:

$$C ( {x}_{D} , {t}_{D} ) = \{ \begin{matrix}0 & {x}_{D} > {Kvt}_{D} \\ \frac{K \sqrt{\frac{{t}_{D} v}{{Kx}_{D}}} - 1}{( K - 1 )} & {Kvt}_{D} > {x}_{D} > \frac{v}{K} {t}_{D} \\ 1 & {x}_{D} < \frac{v}{K} {t}_{D}\end{matrix} \qquad ( 25 )$$

where v is velocity (specific velocity) of oil bank or displacement agent front.

FIG. 7 illustrates an example schematic 700 of an average oil saturation profile of a reservoir 706 during an advanced recovery process when there is an oil bank, according to an example of the present disclosure. Zone I of FIG. 7 illustrates a swept zone of a reservoir 706 having a final oil saturation of S_{oF}. Zone III of FIG. 7 illustrates an oil bank zone having an oil saturation of S_{oB}. Zone II of FIG. 7 illustrates a displacement agent transition zone C₂ where the oil saturation of reservoir 706 is in transition from S_{oF} to S_{oB} as a displacement agent propagates through reservoir 706. Zone V illustrates a residual oil saturation S_{oR} of an unswept zone of reservoir 706. Zone IV illustrates a transition zone C₁ where the oil saturation of reservoir 706 is in transition from S_{oB} to S_{oR} as the oil bank propagates through reservoir 706.

The key locations on FIG. 7 are:

$$\{ \begin{matrix}{x}_{D 1} = \frac{{v}_{C}}{{K}_{C}} {t}_{D} , Injected Fluid Tail \\ {x}_{D 3} = {v}_{C} {K}_{C} {t}_{D} , Injected Fluid Front \\ {x}_{D 1} = \frac{{v}_{B}}{{K}_{B}} {t}_{D} , Oil Bank Tail \\ {x}_{D 4} = {v}_{B} {K}_{B} {t}_{D} , Oil Bank Front\end{matrix} \qquad ( 26 )$$

The average oil saturation as a function of time may be calculated as the summation of oil saturation of different regions as a function of time:

$${\overline{S}}_{o} ( {t}_{D} ) = {\int }_{{x}_{D} = 0}^{{x}_{D} = 1} {S}_{o} ( {t}_{D} ) d {x}_{D} = I + II + III + IV + V \qquad ( 27 )$$

where I, II, III, IV and V are the regions shown in FIG. 7 and calculated as follow:

### Region-I:

$$I = {\int }_{{x}_{D} = 0}^{{x}_{D} = {x}_{D 1}} {S}_{o} ( {x}_{D} , {t}_{D} ) d {x}_{D} = {S}_{oF} ( {x}_{D 1} ) = {S}_{oF} ( \frac{{v}_{C}}{{K}_{C}} {t}_{D} ) \qquad ( 28 )$$

### Region-II:

$${\int }_{{x}_{D 1}}^{{x}_{D 2}} C ( {x}_{D} , {t}_{D} ) d {x}_{D} = {\int }_{{x}_{D 1}}^{{x}_{D 2}} \frac{K \sqrt{\frac{{t}_{D} v}{{Kx}_{D}}} - 1}{K - 1} d {x}_{D} = {[ ( \frac{1}{K - 1} ) ( 2 K \sqrt{\frac{{t}_{D} {vx}_{D}}{K}} - {x}_{D} ) ]}_{{x}_{D 1}}^{{x}_{D 2}} \\ II = {\int }_{{x}_{D} = {x}_{D 1}}^{{x}_{D} = {x}_{D 2}} {S}_{o} ( {x}_{D} , {t}_{D} ) d {x}_{D} = {\int }_{{x}_{D} = {x}_{D 1}}^{{x}_{D} = {x}_{D 2}} [ {S}_{oB} + ( {S}_{oF} - {S}_{oB} ) {C}_{2} ( {x}_{D} , {t}_{D} ) ] d {x}_{D} = {[ {S}_{oB} {x}_{D} + ( {S}_{oF} - {S}_{oB} ) ( \frac{1}{{K}_{C} - 1} ) ( 2 {K}_{C} \sqrt{\frac{{t}_{D} {v}_{C} {x}_{D}}{{K}_{C}}} - {x}_{D} ) ]}_{{x}_{D 1}}^{{x}_{D 2}} \qquad ( 29 )$$

### Region-III:

$$III = {\int }_{{x}_{D} = {x}_{D 2}}^{{x}_{D} = {x}_{D 3}} {S}_{o} ( {x}_{D} , {t}_{D} ) d {x}_{D} = {\int }_{{x}_{D} = {x}_{D 2}}^{{x}_{D} = x 3} [ \begin{matrix}{S}_{oR} + ( {S}_{oB} - {S}_{oR} ) {C}_{1} ( {x}_{D} , {t}_{D} ) + \\ ( {S}_{oF} - {S}_{oB} ) {C}_{2} ( {x}_{D} , {t}_{D} )\end{matrix} ] d {x}_{D} = {[ \begin{matrix}{S}_{oR} {x}_{D} + ( {S}_{oB} - {S}_{oR} ) ( \frac{1}{{K}_{B} - 1} ) ( 2 {K}_{B} \sqrt{\frac{{t}_{D} {v}_{C} {x}_{D}}{{K}_{B}}} - {x}_{D} ) + \\ ( {S}_{oF} - {S}_{oB} ) ( \frac{1}{{K}_{C} - 1} ) ( 2 {K}_{C} \sqrt{\frac{{t}_{D} {v}_{C} {x}_{D}}{{K}_{C}}} - {x}_{D} )\end{matrix} ]}_{{x}_{D 2}}^{{x}_{D 3}} \qquad ( 30 )$$

### Region-IV:

$$IV = {\int }_{{x}_{D} = {x}_{D 3}}^{{x}_{D } = {x}_{D 4}} {S}_{o} ( {x}_{D} , {t}_{D} ) d {x}_{D} = {\int }_{{x}_{D} = {x}_{D 3}}^{{x}_{D} = {x}_{D 4 }} [ {S}_{oR} + ( {S}_{oB} - {S}_{oR} ) C 1 ( {x}_{D} , {t}_{D} ) ] d {x}_{D} = {[ {S}_{oR} {x}_{D} + ( {S}_{oB} - {S}_{oR} ) ( \frac{1}{{K}_{B} - 1} ) ( 2 {K}_{B} \sqrt{\frac{{t}_{D} {v}_{B} {x}_{D}}{{K}_{B}}} - {x}_{D} ) ]}_{{x}_{D 3}}^{{x}_{D 4}} \qquad ( 31 )$$

### Region-V:

$$V = {\int }_{{x}_{D} = {x}_{D 4}}^{{x}_{D} = 1} {S}_{o} ( {x}_{D} , {t}_{D} ) d {x}_{D} = {S}_{oR} ( 1 - {x}_{D 4} ) = {S}_{oR} ( {v}_{B} {K}_{B} {t}_{D} ) \qquad ( 32 )$$

Average oil saturation of reservoir 706 at different times may be calculated as follows: For t_{D}≦t_{D}_{_{BT}}^{B}:

Various regions may be present at various times, therefore, to compute the average oil saturation at a given time, the model may determine what regions are still present at that time to consider that in calculations. Therefore, average oil saturation of reservoir 706 may be different at different times. For example:

1) For before break-through of the oil bank all of the five regions pointed above may be present, therefore:

$${\overline{S}}_{o} ( {t}_{D} ) = {\int }_{{x}_{D} = 0}^{{x}_{D} = 1} {S}_{o} ( {t}_{D} ) d {x}_{D} = I + II + III + IV + V \qquad ( 33 )$$

2) For t_{D}_{_{BT}}^{B}≦t_{D}≦t_{D}_{_{BT}}^{C}:

The fifth region may no longer exists.

$${\overline{S}}_{o} ( {t}_{D} ) = {\int }_{{x}_{D} = 0}^{{x}_{D} = 1} {S}_{o} ( {t}_{D} ) d {x}_{D} = I + II + III + IV \qquad ( 34 )$$

3) For t_{D}_{_{BT}}^{B}≦t_{D}≦t_{D}_{_{SW}}^{B}:

There may be just regions I, II and III remaining

$${\overline{S}}_{o} ( {t}_{D} ) = {\int }_{{x}_{D} = 0}^{{x}_{D} = 1} {S}_{o} ( {t}_{D} ) d {x}_{D} = I + II + III \qquad ( 35 )$$

4) For t_{D}_{_{SW}}^{B}≦t_{D}≦t_{D}_{_{SW}}^{C}:

Regions I and II may be the only regions present at these times.

$${\overline{S}}_{o} ( {t}_{D} ) = {\int }_{{x}_{D} = 0}^{{x}_{D} = 1} {S}_{o} ( {t}_{D} ) d {x}_{D} = I + II \qquad ( 36 )$$

5) For t_{D}_{_{SW}}^{C}≦t_{D}:

Only region I may exist.

$${\overline{S}}_{o} ( {t}_{D} ) = {\int }_{{x}_{D} = 0}^{{x}_{D} = 1} {S}_{o} ( {t}_{D} ) d {x}_{D} = I \qquad ( 37 )$$

Accordingly, the above equations may describe the average oil saturation of reservoir 706 as a function of time ( S̅ₒ= S̅ₒ(t_{D}) for the entire flooding time. Therefore, as described above, the same general advanced recovery forecasting model may be used to determine the average oil saturation of a reservoir as a function of time for a plurality of different advanced recovery processes. As such, the performances of different advanced recovery processes may be compared using the same general advanced recovery forecasting model of the present disclosure.

The above described model may be validated by comparing well production results from advanced recovery processes with predicted results for the reservoir using the above described advanced recovery forecasting model. To validate the general isothermal advanced recovery forecasting model numerous field and pilot EOR (chemical EOR and gas flooding) and waterflood data may be used. Additionally, as described above, the history matching data may be used to tune and determine a Koval factor and final average oil saturation (S_{oF}) for the historical data. The Koval factor(s) and final average oil saturation (S_{oF}) may be used to predict results of a similar advanced recovery process in a similar reservoir. Additionally, as mentioned above, in some embodiments, the oil saturation of an oil bank (S_{oB}) may be determined using history matching data similarly to the process described below for Koval factors and final average oil saturation of a reservoir.

For example, cumulative oil production and oil cut of several oil reservoirs and wells may be used to examine the ability of the general advanced recovery forecasting model in waterflood history matching. Additionally, the waterflood history matching may be used to determine a water front Koval factor (K_{W}) and final average oil saturation (S_{oF}) to predict the results of waterflood recovery processes with different reservoir types.

Water front Koval factor (K_{W}) and the final average oil saturation (S_{oF}) a reservoir may be determined by first inputting an initial value for each of K_{W} and S_{oF} in the general advanced recovery forecasting model. As mentioned above, the Koval factor may indicate the mobility of a fluid in a reservoir and may be any value between one and can be as high as thirty. A water flood may be more mobile than a polymer flood, but less mobile than a gas flood and may have a Koval factor somewhere around ten. Therefore, an initial water front Koval factor (K_{W}) of ten may be selected for a water flood.

The initial value of S_{oF} may be based on a value between the oil saturation remaining after a conventional recovery process but before any advanced recovery process has begun (S_{oR}) and an ideal residual oil saturation (Sₒᵣ) that may remain after the waterflood process. Sₒᵣ may be determined based on a small scale laboratory estimation. Sₒᵣ is typically less than S_{oF} because Sₒᵣ assumes that the entire reservoir has been swept by an advanced recovery process, whereas typically some portions of a reservoir may not be swept by the advanced recovery process. Therefore, a value between Sₒ, and S_{oR} may be chosen for the initial value of S_{oF}.

Once initial values of S_{oF} and K_{W} have been selected, the velocity (v_{ΔS}) may be determined from fractional flow theory. Equation 38 describes the velocity of a displacement front:

$${v}_{Δ S} = \frac{1 - ( 1 - {f}_{ol} )}{( 1 - {S}_{oR} ) - ( 1 - {S}_{oF} )} \qquad ( 38 )$$

where f_{oI} is the initial oil cut at the start of the waterflood process.

Using the general advanced recovery forecasting model, the average oil saturation may be calculated as a function of time using the velocity (v_{ΔS}) of the water front and K_{W} as described with respect to FIGS. 4a-4c above. Based on the average oil saturation as a function of time, the recovery efficiency, cumulative oil production and oil cut may also be computed as functions of time. Such computations are calculable as below:

The recovery efficiency may be calculated as described by Equation 39:

$${E}_{R} ( t ) = \frac{{S}_{oR} - {\overline{S}}_{o} ( t )}{{S}_{oi}} \qquad ( 39 )$$

where Sₒᵢ is original oil saturation of the reservoir before any production (primary or advanced) has occurred, E_{R} is the recovery efficiency (oil recovered expressed as a fraction of the original oil in place) and t is real or dimensionless time.

Nₚ(t)=E_{R}(t)(OOIP) (40)

where N_{P} is cumulative oil production and OOIP is original oil in place.

Calculating the recovery efficiency may enable computing the volumetric sweep efficiency Eᵥ of a displacement agent using ultimate displacement efficiency, E_{D}. Note that these are a posteriori calculations here; the effects of all of these quantities may be subsumed into the Koval factor.

$$\begin{matrix}{E}_{V} ( t ) = \frac{{E}_{R} ( t )}{{E}_{D}} & ( 41 ) \\ {E}_{D} = \frac{{S}_{oR} - {S}_{or}}{{S}_{oi}} & ( 42 )\end{matrix}$$

where laboratory (ideal) Sₒᵣ is residual oil saturation to waterflood, as described above. In some embodiments of the present disclosure using the E_{D} (ultimate displacement efficiency) in calculation of E_{V} (volumetric sweep efficiency) may be compatible with the assumption of locally segregated flow explained above. Oil cut may be calculated using Equation 43:

$$Oil Cut = \frac{Δ {\overline{S}}_{o}}{Δ {t}_{D}} = \frac{{\overline{S}}_{o}^{n + 1} - {\overline{S}}_{o}^{n}}{{t}_{D}^{n + 1} - {t}_{D}^{n}} \qquad ( 43 )$$

where Sₒⁿ⁺¹, Sₒⁿ, t_{D}ⁿ⁺¹ and t_{D}ⁿ are average oil saturations and injected fluid pore volumes at subsequent flooding times of tⁿ⁺¹ and tⁿ. Accordingly, by calculating the average oil saturation of a waterflooding process as a function of time using the general advanced recovery forecasting model of the present disclosure, the oil cut of a reservoir from waterflooding may be predicted.

History matching may be done between the oil production forecasted (e.g., oil cut, volumetric sweep, recovery efficiency, oil saturation over time, oil rate, cumulative oil recovery) forecasted using the general advanced recovery forecasting model and actual oil production data. The history matching may be based on the technique of minimization of error between actual and forecasted data. Using the error minimization technique, the water front Koval factor (K_{W}) and final average oil saturation (S_{oF}) values may be modified for another estimation by the general advanced recovery forecasting tool based on the new values until the historical data and the forecasted data match each other relatively closely within a desired margin of error. Therefore, the water front Koval factor (K_{W}) and final average oil saturation (S_{oF}) may be determined for different water flood recovery processes used for different reservoirs. Accordingly, such values of K_{W} and S_{oF} may be used by the general advanced recovery forecasting model to forecast the results of waterflooding with respect to similar reservoirs.

Koval factors may be determined for a reservoir based on Koval factors determined for each well associated with a reservoir. For example, a Koval factor for a reservoir may be between the well with the maximum Koval factor and the well with the minimum Koval factor.

Table 1 illustrates a list of example water flood Koval factors determined for a plurality of wells of a plurality of reservoirs. The last column in Table 1 is the coefficient of determination (square of the correlation coefficient, R²) that is a measure of the strength of the history match with the forecasted data. The closer the R² to one, the stronger the match.

TABLE 1
Summary of fitted Koval factor (K_{W}) for history match of waterflooding

| | | Well Koval | Reservoir Koval | |
|---|---|---|---|---|
| Reservoir Name | Well Name | Factor | Factor | R² |
| Sand-A | Well-A1 | 3.00 | 7.13 | 0.992 |
| | Well-A2 | 5.48 | | |
| | Well-A3 | 2.54 | | |
| | Well-A4 | 8.37 | | |
| | Well-A5 | 3.50 | | |
| | Well-A6 | 4.75 | | |
| | Well-A7 | 15.27 | | |
| | Well-A8 | 12.98 | | |
| Sand-B | Well-B1 | 1.46 | 3.74 | 0.949 |
| | Well-B2 | 10.31 | | |
| | Well-B3 | 2.82 | | |
| Sand-C | Well-C1 | 6.87 | 4.00 | 0.899 |
| | Well-C2 | 1.50 | | |
| Sand-D | Well-D1 | 2.70 | 4.58 | 0.887 |
| | Well-D2 | 5.00 | | |

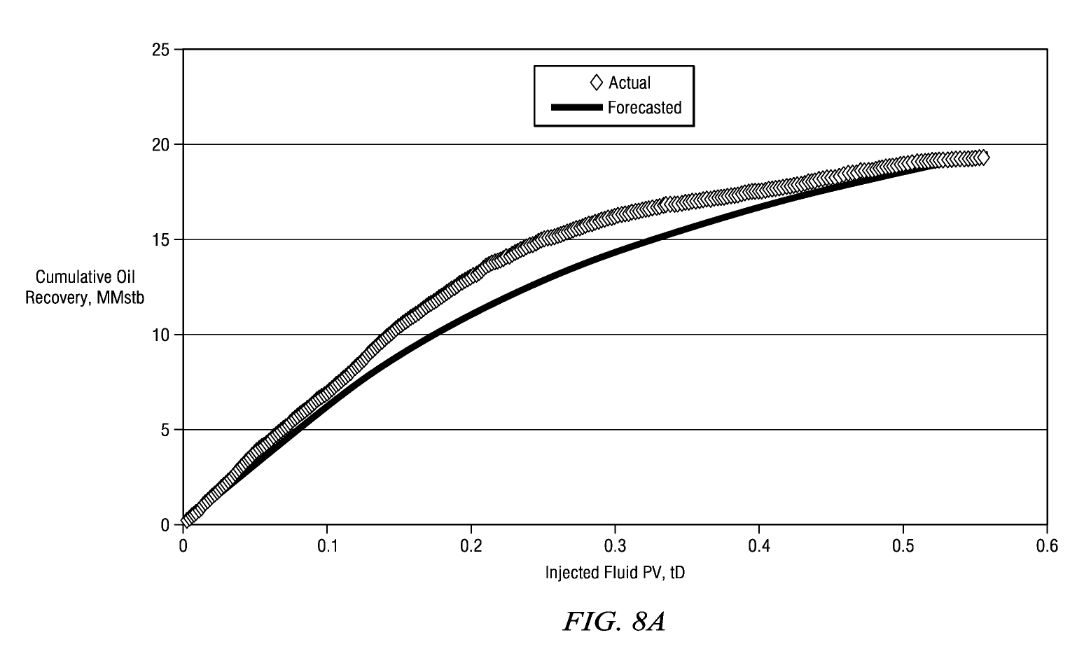

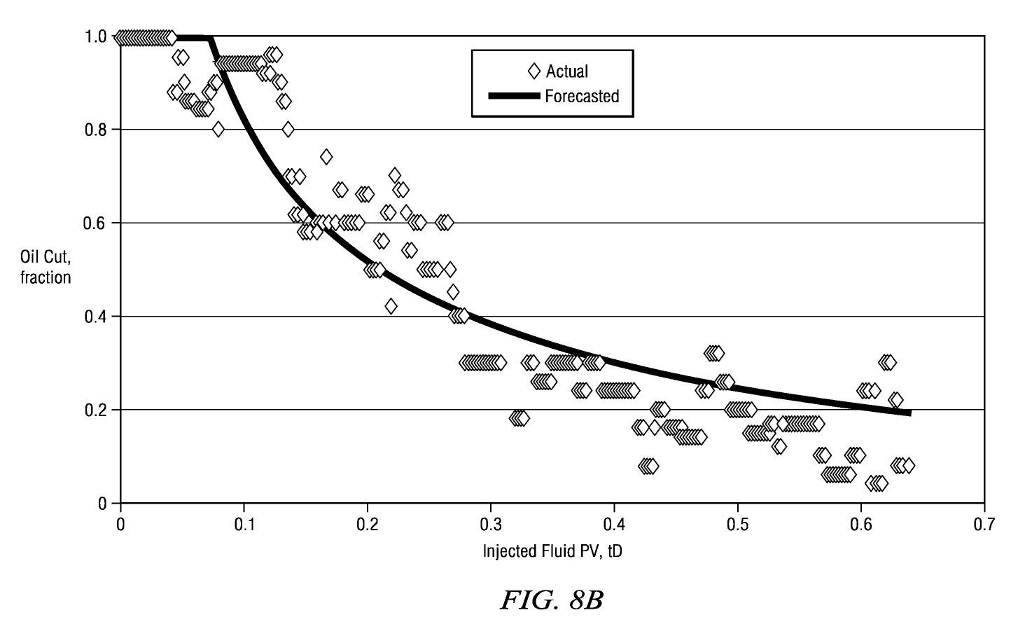

FIGS. 8a and 8b illustrate example of the predicted (forecasted) waterflood data computed using the general advanced recovery forecasting model of the present disclosure vs. actual data for a reservoir. As shown in FIGS. 8a and 8b, the general advanced recovery forecasting model fits the field data very well.

As discussed above, the forecasting model may also be used to predict other advanced recovery process (e.g., EOR process) results, accordingly the following sections illustrate validation of the model against isothermal EOR processes including chemical EOR (polymer (P), surfactant-polymer (SP) and alkaline surfactant-polymer (ASP) flooding) and solvent (CO₂) flooding (miscible/immiscible, WAG and continuous gas flood) as well as waterflooding that was represented before. Additionally, applicable Koval factors and final average oil saturation of the EOR processes may be determined using the history matching of the EOR processes similarly to as described above with respect to waterflood history matching. Examples of history matching results of chemical EOR and solvent (CO₂) flooding EOR processes are included in the present disclosure.

### Chemical EOR

Chemical EOR may be useful in oil fields with small to moderate oil viscosity, salinity and temperature. In chemical EOR, different chemicals acting as displacement agents are injected to control the mobility ratio (between displacing and displaced fluids) by using polymers and/or to decrease the interfacial tension between the phases (and so reaching to miscibility) by using surface-active agents (surfactants; as in SP or ASP flooding) to bring about improved oil recovery. The production history data (such as cumulative oil recovery, oil cut, average oil saturation) of many pilot and field chemical EOR processes including polymer (P), surfactant-polymer (SP), alkaline surfactant-polymer (ASP) floods may be used for history matching and validation of the general isothermal EOR forecasting tool.

The history matching procedure may be similar to waterflooding with the difference being that an additional Koval factor may be determined because of the possible existence of two displacement fronts (one between the displacement agent (chemical) of a swept zone and an oil bank zone, the other front may be between the oil bank zone and the unswept zone (e.g., displacement front 515 and oil bank front 517, respectively, of FIG. 5)). Accordingly, the history matching parameters in the present example are a displacement agent (chemical) Koval factor (K_{C}), an oil bank Koval factor (K_{B}) and the final average oil saturation (S_{oF}) of the reservoir. The initial value of K_{C} may be based on the mobility of the polymer, which may be less than that of water and may be around three. The initial value of K_{B} may be based on the mobility of the oil bank and may be fairly small (e.g., between one and three) based on the relative stability of the oil bank. Further, similar to as described above with respect to waterflooding, the initial value of S_{oF} may be between the oil saturation remaining after a conventional recovery process (S_{oR}) and the ideal residual oil saturation (Sₒᵣ) after the chemical EOR process, as determined based on a laboratory experiment.

The velocities of oil bank (v_{B}) and displacement agent (v_{C}) fronts can be determined from fractional flow curve construction. Equations 44 and 45 describe velocities of displacement agent and oil bank fronts respectively.

$$\begin{matrix}{v}_{C} = \frac{1}{1 - {S}_{oF}} & ( 44 ) \\ {v}_{B} = \frac{{f}_{wI} - {v}_{C} ( 1 - {S}_{oB} )}{{S}_{w}^{I} - ( 1 - {S}_{oB} )} & ( 45 )\end{matrix}$$

where f_{wI} is the initial water cut (f_{wI}=I−f_{oI}) at initial water saturation (S_{wI}).

Once the velocities of the displacement agent and oil bank are determined, the average oil saturation of the reservoir may be determined as a function of time, as described above with respect to FIG. 5. The average oil saturation of the reservoir as a function of time may be used to determine other production metrics such as recovery efficiency, volumetric sweep, oil rate, oil cut, cumulative oil recovery and oil bank displacing fluid regions. One or more of the predicted production metrics may be compared with actual data and K_{C}, K_{B} and/or S_{oF} may be modified for another estimation by the general advanced recovery forecasting tool based on the new values until the historical data and the forecasted data match each other relatively closely within a desired margin of error. Accordingly, such values of K_{C}, K_{B}, and S_{oF} may be used by the general advanced recovery forecasting model to forecast the results of similar chemical EOR process with respect to similar reservoirs.

### Polymer (P), Surfactant-Polymer (SP) and Alkaline-Surfactant-Polymer (ASP) Flood History Matching

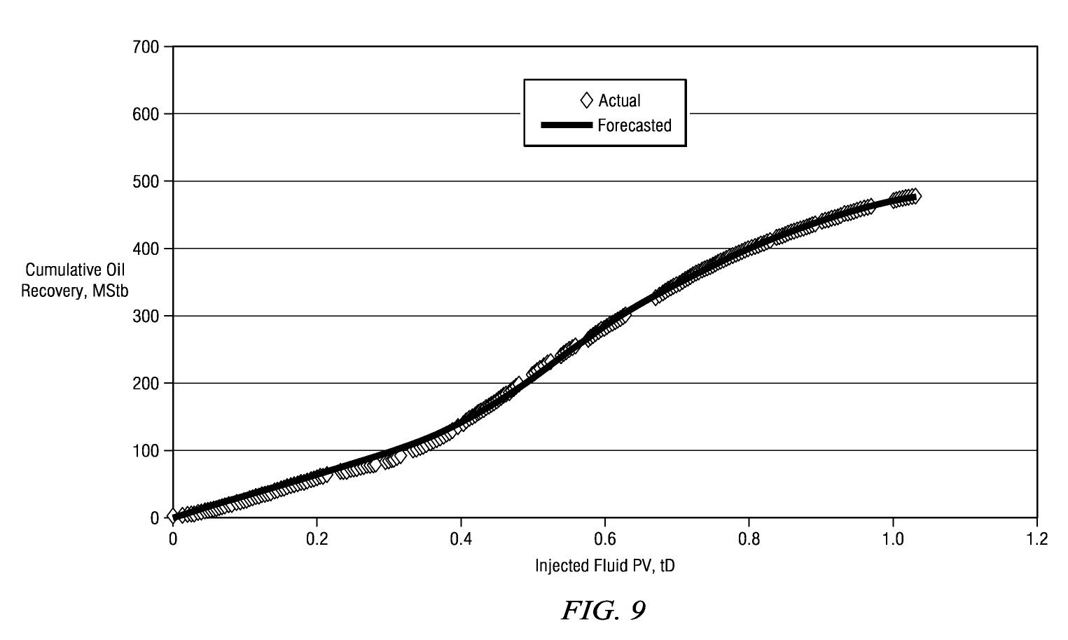

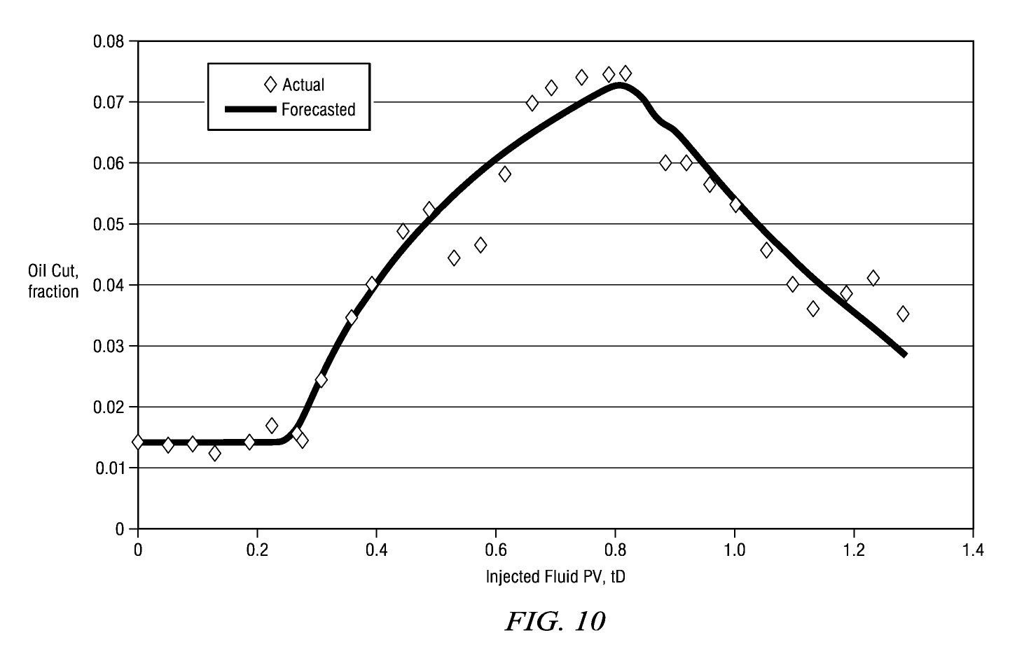

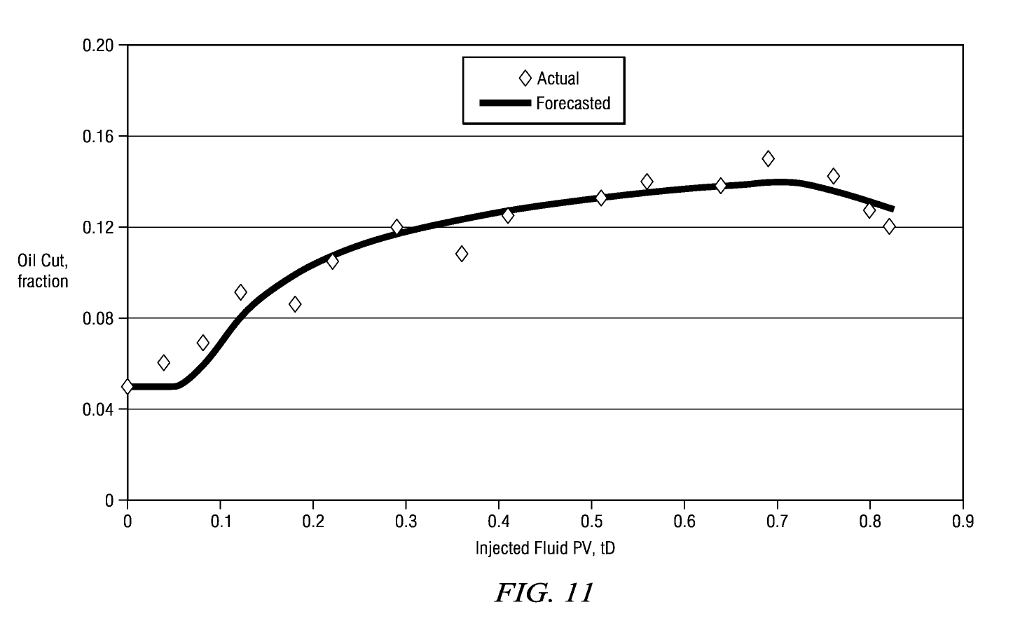

Various field and pilot chemical EOR projects may be used for history matching. FIGS. 9 to 11 show examples of the polymer (P) flood, surfactant-polymer (SP) flood and alkaline-surfactant-polymer (ASP) flood history, respectively, matching predictive results of the general advanced recovery forecasting model of the present disclosure. As seen in FIGS. 9 to 11, the advanced recovery forecasting model show strong abilities for history matching of the chemical EOR processes.

### Solvent (CO₂) Flooding/WAG EOR

Water-alternating-gas (WAG) floods are another EOR process. A WAG EOR process may increase the sweep efficiency of miscible/immiscible gas flooding by reducing the mobility ratio between injected gas and the formation oil of a reservoir, which may be a problem in solvent EOR floods with very poor sweep and early gas breakthrough In the present example, history data of several CO₂/WAG flooding EOR may be used for history matching by the general isothermal EOR forecasting model of the present disclosure. The procedure of history matching is similar to chemical EOR with the same number of matching parameters (K_{S}, K_{B}, S_{oF}). In the WAG EOR process model, K_{S} may be used (solvent front Koval factor) instead of K_{C} (chemical front Koval factor) to represents the shape of the solvent-oil bank front mainly controlled by reservoir heterogeneity, pressure, mass transfer between phases and WAG ratio (if it is a water alternative gas flooding instead of continuous gas flooding).

The velocities of the oil bank (v_{B}) and displacement agent (v_{S}) fronts are calculated from the fractional flow curve construction. Equations 46 and 47 express velocities of displacement agent (solvent) and oil bank fronts respectively.

$$\begin{matrix}{v}_{s} = \frac{1 - {f}_{wJ}}{( 1 - {S}_{oF} ) - {S}_{wJ}} & ( 46 ) \\ {v}_{B} = \frac{{f}_{wI} - {f}_{wB}}{{S}_{wI} - {S}_{wB}} = \frac{{f}_{wI} - ( {v}_{s} {S}_{wB} + {f}_{wJ} - {v}_{s} {S}_{wJ} )}{{S}_{wI} - {S}_{wB}} & ( 47 )\end{matrix}$$

where f_{wI} is the initial water cut (f_{wI}=I−f_{oI}) at initial water saturation (S_{wI}), S_{wJ} and f_{wJ} are the injection point water saturation and water cut on water-solvent fractional flow curve. S_{wB} and f_{wB} are oil bank saturation and water cut.

Once the velocities of the displacement agent and oil bank are determined, the average oil saturation of the reservoir may be determined as a function of time, similarly to as described above with respect to FIG. 5. As described above, the average oil saturation of the reservoir as a function of time may be used to determine other production metrics such as recovery efficiency, volumetric sweep, oil rate, oil cut, cumulative oil recovery and oil bank displacing fluid regions. One or more of the predicted production metrics may be compared with actual data and K_{S}, K_{B} and/or S_{oF} may be modified for another estimation by the general advanced recovery forecasting tool based on the new values until the historical data and the forecasted data match each other relatively closely within a desired margin of error. Accordingly, such values of K_{S}, K_{B}, and S_{oF} may be used by the general advanced recovery forecasting model to forecast the results of similar WAG EOR process with respect to similar reservoirs.

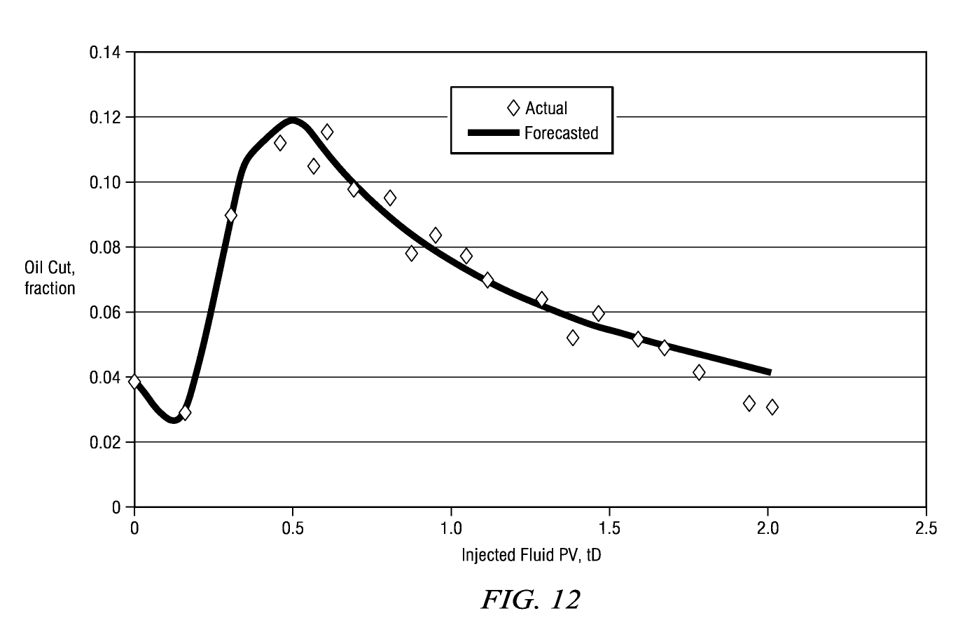

FIG. 12 shows results of a Scurry Area Canyon Reef Operators Committee (SACROC)-Four Pattern (4PA) CO₂/WAG flooding EOR history matching predictive results of the Advanced recovery forecasting model of the present disclosure. As shown in FIGS. 8-12, the results of the general advanced recovery forecasting model may match the field solvent (gas) flooding EOR as well as it does the chemical EOR and waterflooding field results.

A summary of field/pilot history matching results with corresponding history matching variables obtained for each field/pilot is shown in Table 2. As one can see values of displacement agent Koval factors (K₁, K_{C} or K_{S}) are much larger for solvent/WAG flooding, which reflects the higher mobility ratio of gas compared to chemical EOR that takes advantage of polymer for mobility control. Waterflooding Koval factors (Table 1) stand between chemical EOR (K_{c}) and solvent (gas) flooding (K_{S}). Oil bank Koval factors (K₂) are usually smaller than displacement agent Koval factor (K₁) showing that an oil bank front is usually more stable than a displacement agent front. Table 3 shows a summary of history matching results for SP and ASP coreflood laboratory experiments. As Table 3 shows, both chemical and the oil bank Koval factor (K_{C} and K_{B}) values are small and very close to 1 reflecting much less heterogeneity in cores compared to field EOR projects. The saturation difference (ΔSₒ) values are relatively larger for corefloods compared to field EOR projects because of larger sweep efficiency of coreflood experiments that are basically 1D displacement processes. The last column in Table 2 and 3 is the coefficient of determination (square of correlation coefficient, R²) that is a measure of strength of the history match (fit). The closer the R² value to 1 the stronger the fit. Accordingly, the history matching results help show that the general advanced recovery forecasting model may accurately predict the production results of a plurality of different advanced recovery processes.

TABLE 2
Field/pilot history matching variables for different EOR processes.

| | History Matching Parameters | | | |
|---|---|---|---|---|
| | | | ΔSₒ = | |
| Field Name | *K₁ | *K₂ | S_{oR} − S_{oF} | R² |
| Chateaurenard polymer flood | 4.528 | 1.082 | 0.305 | 0.998 |
| Courtenay polymer flood | 4.599 | 2.070 | 0.274 | 0.994 |
| Daqing PO polymer flood | 1.846 | 1.751 | 0.265 | 0.998 |
| Marmul polymer flood | 3.527 | 1.032 | 0.500 | 0.988 |
| Minnelusa polymer flood | 5.326 | 1.320 | 0.365 | 0.995 |
| North Burbank polymer flood | 2.292 | 5.014 | 0.230 | 0.999 |
| Sleepy Hollow polymer flood | 2.870 | 2.100 | 0.220 | 0.997 |
| Benton SP flood | 2.471 | 1.575 | 0.089 | 0.852 |
| Sloss SP flood | 3.714 | 2.317 | 0.204 | 0.995 |
| Berryhill Pilot SP flood | 2.578 | 2.250 | 0.066 | 0.917 |
| Wilmington SP flood | 2.622 | 1.776 | 0.062 | 0.950 |
| Borregos SP flood | 1.869 | 1.666 | 0.061 | 0.999 |
| Bell Creek SP flood | 1.640 | 1.187 | 0.054 | 0.977 |
| Bell Creek Confined SP flood | 1.989 | 1.211 | 0.158 | 0.971 |
| Big Muddy Field SP flood | 3.432 | 7.624 | 0.016 | 0.956 |
| Big Muddy Pilot SP flood | 2.486 | 1.467 | 0.110 | 0.954 |
| Bradford 7 SP flood | 7.841 | 1.997 | 0.064 | 0.888 |
| Bradford 8 SP flood | 3.907 | 1.759 | 0.045 | 0.965 |
| Manvel SP flood | 8.144 | 4.048 | 0.057 | 0.999 |
| North Burbank SP flood | 4.430 | 2.516 | 0.035 | 0.913 |
| Berryhill Field SP flood | 8.247 | 3.606 | 0.077 | 0.828 |
| 1M-2.5 SP flood | 2.901 | 1.454 | 0.093 | 0.919 |
| 1M-5.0 SP flood | 3.551 | 1.414 | 0.095 | 0.997 |
| Salem SP flood | 8.019 | 3.844 | 0.076 | 0.823 |
| Chateaurenard SP flood | 9.046 | 2.504 | 0.409 | 0.999 |
| Robinson SP flood | 4.124 | 1.584 | 0.188 | 0.893 |
| Loudon SP flood | 1.696 | 2.300 | 0.157 | 0.960 |
| Daqing XF ASP flood | 11.123 | 2.995 | 0.361 | 0.924 |
| Karamay ASP flood | 4.951 | 2.511 | 0.259 | 0.894 |
| Cambridge ASP flood | 2.063 | 1.613 | 0.400 | 0.993 |
| Tanner ASP flood | 13.334 | 2.126 | 0.463 | 0.997 |
| Lost Soldier Tensleep WAG flood | 37.930 | 6.048 | 0.365 | 0.957 |
| SACROC 4PA WAG flood | 39.557 | 7.594 | 0.216 | 0.925 |
| SACROC 17PA WAG flood | 81.883 | 9.280 | 0.412 | 0.998 |
| Wertz Tensleep WAG flood | 58.215 | 10.202 | 0.284 | 0.945 |
| West Sussex WAG flood | 48.166 | 14.203 | 0.056 | 0.977 |
| Twofreds WAG flood | 63.258 | 5.563 | 0.212 | 0.914 |
| Rangely WAG flood | 76.795 | 12.502 | 0.279 | 0.998 |
| Slaughter WAG flood | 6.891 | 3.041 | 0.322 | 0.883 |

*K₁ and *K₂ are displacement agent and oil bank front Koval factors respectively.

TABLE 3
History matching parameters for coreflood laboratory experiments.

| | History Matching Parameters | | | |
|---|---|---|---|---|
| Coreflood# | *K_{C} | *K_{B} | ΔSₒ = S_{oR} − S_{oF} | R² |
| Core#A: SP flood | 1.357 | 1.001 | 0.395 | 0.925 |
| Core#B: ASP flood | 1.361 | 1.001 | 0.338 | 0.962 |
| Core#C: ASP flood | 1.619 | 1.118 | 0.25 | 0.996 |
| Core#D: ASP flood | 1.316 | 1.001 | 0.306 | 0.898 |
| Core#E: ASP flood | 1.221 | 1.030 | 0.429 | 0.981 |

*K_{C} and *K_{B} are chemical and oil bank front Koval factors respectively.

The above history matching may be used to validate the general advanced recovery forecasting model of the present disclosure as well as to determine Koval factors for and the final average oil saturation for predicting the results of similar advanced recovery methods with similar reservoirs. However, the general advanced recovery forecasting model of the present disclosure may also predict the performance of different advanced recovery processes for a given reservoir when little to no production (injection) history is present. Production history in many cases is not available and may take a prohibitively long time to acquire. Accordingly, such a functionality may be desirable to predict the advanced recovery results for purposes such as quantitative advanced recovery forecasting, advanced recovery screening, advanced recovery evaluation and decision analysis, economical evaluation and etc. for an asset of reservoirs or a single pilot/reservoir with little to production history or little to no production history from similar reservoirs/wells.

As mentioned above, to predict advanced recovery performance, the functionality of the forecasting model variables (Koval factors (K_{B}, K_{C} and K_{S}) and final average oil saturation (S_{oF})) to reservoir/recovery process variables (such as reservoir heterogeneity, mobility ratio, reservoir pressure and WAG ratio) may be found. In other words, correlations between the forecasting model variables and reservoir/recovery process variables may be found to determine forecasting model variables that may reliably represent the reservoir/recovery process variables in the forecasting model for prediction of advanced recovery results.

For this purpose, comprehensive numerical estimation studies may be performed for each secondary and tertiary recovery process based on an Experimental Design & Response Surface Modeling (RSM) technique that gives a desired number and design of runs based on the number, type and range of input variables. This may be done using any suitable reservoir numerical estimator, such as, GEM (general equation of state compositional simulator, a Computer Modeling Group (CMG) simulation package) for solvent (gas) flooding/WAG and UTCHEM (University of Texas Chemical EOR Simulator) for chemical EOR and waterflooding estimations.

An estimator may be stored as computer readable instructions on a computer readable medium that are operable to perform, when executed, one or more of the steps described below. The computer readable media may include any system, apparatus or device configured to store and retrieve programs or instructions such as a hard disk drive, a compact disc, flash memory or any other suitable device. The simulators may be configured to direct a processor or other suitable unit to retrieve and execute the instructions from the computer readable media.

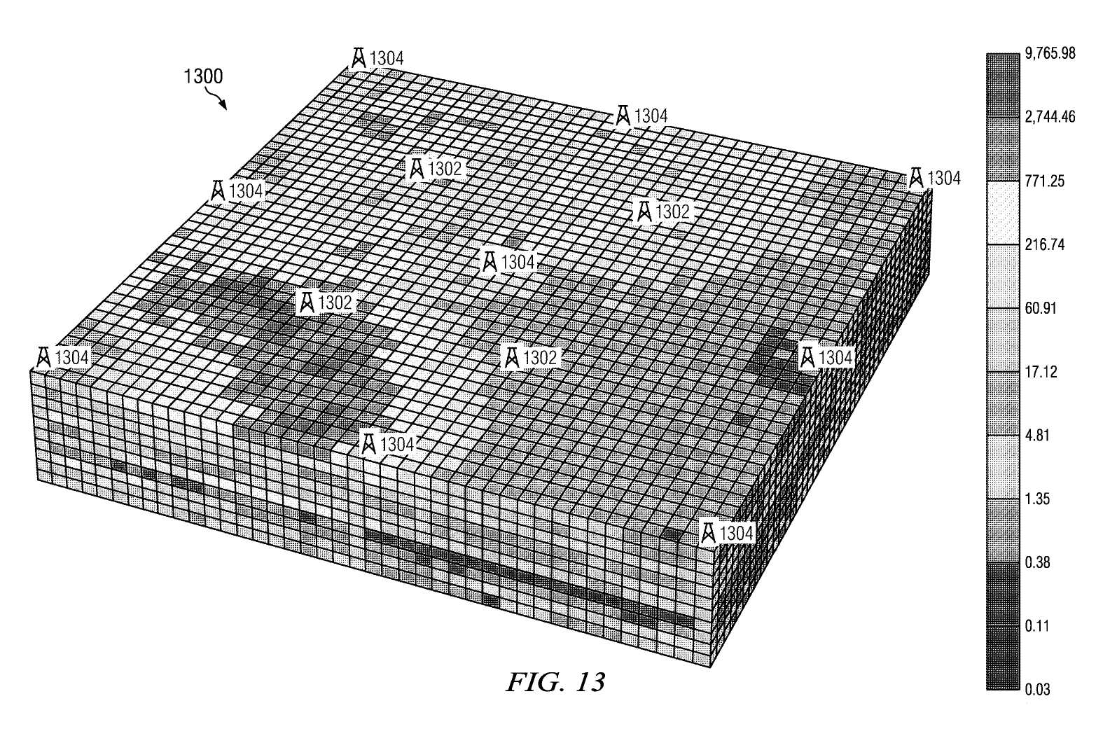

The simulator may be used to generate a model of the reservoir where EOR processes may be implemented. FIG. 13 illustrates a reservoir 1300 modeled for determining advanced recovery process results and variables in accordance with an example of the present disclosure.

For the example of the present disclosure, the reservoir model for the experimental design simulation study is a five spot pattern pilot surrounded with some quarter of five spots (with a total of five spot patterns). The model is 2000 ft×2000 ft×100 ft in x, y and z directions respectively (which covers about 92 acres) and contains four pressure constrained production wells 1302 (pressure constrained) and nine rate constrained injection wells 1304 (rate constrained). This reservoir model is similar to a Salem EOR pilot. In the present example, both production and injection wells are vertical and completed in all the layers of the simulation model. Areal gridding sensitivities concluded the proper grid size for the model to be 41×41×10 in x, y and z directions respectively (total grid number of 16,810 cells with 48.78 ft on the sides and 10 ft thick making 10 layers vertically). This grid design showed satisfactory results compared to more finely gridded models.

Reservoir heterogeneity may be applied in both horizontal and vertical directions. To achieve this, FFT simulation software (Fast Fourier Transform; a reservoir heterogeneity modeling software) may be used with a wide range of Dykstra-Parsons coefficient (V_{DP}) along with geostatistical dimensionless correlation length (λₓ or Lₓ; ratio of the range of the semivariogram to pilot characteristic length in x direction; for the present models λₓ=λ_{y} and λ_{z} may be selected such that they represent the number of geological layers. In the present disclosure, λ may refer to λₓ unless specified otherwise. These two reservoirs may also be used in experimental design along with recovery process variable/s. Reservoir permeability may be normally distributed log.

The reservoir of FIG. 13 may also include fluid properties that may be simulated. For waterflooding simulation studies, oils with different viscosities may be used to make the proper endpoint mobility ratio (M^{o}:0.5 to 50; suggested by experimental design) for each simulation. In case of chemical EOR, a viscous oil (μₒ=80 cp) causing an adverse mobility ratio of 100 for waterflooding may be selected and the desired mobility ratio of the flood for each simulation may be controlled by polymer viscosity to satisfy the wide range of M^{o} of 0.1 to 30 applied in experimental design.

For solvent/WAG flooding EOR (done as simultaneous water/gas injection), the fluid may be West Welch reservoir fluid, a Permian Basin filed, with API gravity of 32 and small percentage of C₁ and C₃₀⁺ compared to intermediate components which may be a proper candidate for CO₂ WAG flooding and may be used for simulation studies.

The reservoir may also be simulated and modeled to have a set of initial conditions. In the present example, the reservoir may be initiated at uniform oil saturation of 0.7 for waterflooding and chemical EOR and 0.8 for solvent (gas)/WAG flooding. The residual oil saturation to waterflood (S_{orw}) is 0.28. Waterflooding simulations may be done by injecting 1.5 PV of water but for EOR processes simulations, the reservoir may first be waterflooded up to 1 PV and then continued to EOR (as tertiary EOR). The simulations may be isothermal and the reservoir model may be initiated at a uniform pressure of 2125 psi for solvent flooding which is 15 psi above MMP (minimum miscibility pressure) of 2110 psi.

Following the generation of the reservoir, various estimations using the general advanced recovery forecasting model of the present disclosure may be run with respect to the reservoir to predict the performance of the various secondary and tertiary recovery processes. Some variables that may govern the performance (efficiency) of each advanced recovery process may be selected based on a detailed sensitivity analysis using a Winding Stairs sensitivity analysis method and reservoir engineering knowledge. For example, for chemical EOR processes, the endpoint mobility ratio (M^{o}) that includes the effects of the viscosity and relative permeability may be used for experimental design and for solvent flooding/WAG, WAG ratio (W_{R}; water to gas injection ratio) and pressure may be used for experimental design as the recovery process variable. Reservoir heterogeneity (represented by Dykstra-parsons coefficient; V_{DP}) and geostatistical dimensionless correlation length λ (defined in the reservoir model section) may be chosen as reservoir variables in experimental design.

V_{DP} may be a standard method of measuring permeability in a hydrocarbon reservoir. V_{DP} may be calculated as the spread or distribution of permeability of the reservoir as taken from core or log data of the reservoir. In some embodiments, all the distribution of permeability of the reservoir data may be combined to obtain a single estimation of V_{DP} for the reservoir. The mobility ratio (M^{o}) may be a standard way of expressing the relative mobility of fluids (e.g., displacement agent and oil) in a reservoir. M^{o} may depend on the petrophysical properties of the reservoir as well as the viscosities of the respective fluids. These properties may be measured in the laboratory on fluids and materials that may be extracted from the reservoir. The properties may be measured at reservoir temperature and pressure to obtain better predictions of the mobility ratio. The autocorrelation length (λ) may represent a measure of the heterogeneity in the reservoir. The autocorrelation length may be extracted from the geology data of a formation associated with the reservoir or by analyzing the permeability data on a well-by-well basis. Based on V_{DP}, M^{o}, and λ, the Koval factor for a displacement agent or oil in an oil bank zone may be determined using calculations similar to those described above with respect to Equation 48.

Tables 4 to 6 show the ranges of the different variables used for experimental design of waterflooding and different recovery processes in the present example.

The chosen bottom hole pressure (BHP) range for solvent/WAG EOR may vary between MMP (minimum miscibility pressure) of the reservoir fluid (2110 psi) and fracturing pressure of the reservoir. Considering these, the BHP of the pressure-constrained vertical producers varies from 2125 (which is 15 psi greater than the MMP) up to 3500 psi.

TABLE 4
Range of variations of reservoir/process variables
used for experimental design of waterflooding.

| Recovery Process/Reservoir Variable | Range of Variation |
|---|---|
| M^{o}, dimensionless | 0.5-50 |
| V_{DP}, dimensionless | 0.4-0.9 |
| λ, dimensionless | 0.5-10 |

TABLE 5
Range of variations of reservoir/process variables used for
experimental design of chemical EOR processes.

| EOR Process/Reservoir Variable | Range of Variation |
|---|---|
| M^{o}, dimensionless | 0.1-30 |
| V_{DP}, dimensionless | 0.4-0.9 |
| λ, dimensionless | 0.5-10 |

TABLE 6
Range of variations of reservoir/process variables used for
experimental design of solvent (gas) flooding/WAG EOR processes.

| EOR Process/Reservoir Variable | Range of Variations |
|---|---|
| W_{R}, dimensionless | 0.5-5 |
| (P-MMP)/MMP, dimensionless | 1.007-1.659 |
| V_{DP}, dimensionless | 0.4-0.9 |
| λ, dimensionless | 0.5-10 |

The experimental design output may suggest a desired design and number of runs (with different reservoir/process variables) that may be used for a systematic and comprehensive numerical simulation study of each EOR process.

For example, for polymer flooding, polymer floods with different M^{o} (end point mobility ratio), reservoir heterogeneity (V_{DP}) and dimensionless correlation length (λ) may be simulated with a simulator such as UTCHEM. Results of the simulation may then be history matched with the EOR forecasting tool (which may be run by the above mentioned simulator) to identify the variations of chemical (polymer) front Koval factor (K_{C}), oil bank front Koval factor (K_{B}) and final average oil saturation (S_{oF}) with changes of process/reservoir variables (M^{o}, λ and V_{DP}). In some embodiments, history matching of polymer flood numerical simulations show that the mobility ratio may be the most influential advanced recovery process variable that governs the efficiency of oil recovery. Therefore, choosing a displacement agent in polymer floods with a favorable mobility ratio (e.g., M^{o} less than three) may compensate for unfavorable effects of reservoir heterogeneity.

WAG numerical simulations may also be done using a simulator (e.g., GEM) in the form of simultaneous water alternative gas (SWAG) flooding. Similar procedures of experimental design may be done within the extensive range of process/reservoir variables (W_{R} (WAG ratio)), producing bottom hole pressure (BHP), reservoir heterogeneity (V_{DP}) and dimensionless correlation length (λ) shown in Table 6. The optimum design and the number of simulations obtained using the experimental design may be used for WAG simulations using GEM. The results of the simulation may then be history matched using the EOR forecasting model described above to find the functionality and correlations of solvent front Koval factor (K_{S}), oil bank front Koval factor (K_{B}) and final average oil saturation (S_{oF}) with respect to changes of process/reservoir variables (W_{R}, P, λ and V_{DP}). In contrast to polymer floods, history matching of WAG numerical solutions indicate that in solvent (gas) flooding/WAG recovery processes, reservoir heterogeneity may be the most sensitive governing factor that affects the oil recovery and sweep efficiency. Additionally, the unfavorable effect of reservoir heterogeneity may substantially worsen for values of V_{DP} that are approximately greater than or equal to 0.8 such that a decreasing WAG ratio (e.g., increasing gas injection) may not compensate for the heterogeneity. In such situations, the general advanced recovery forecasting model may indicate that the use of foam with gas in the WAG process may be desirable.

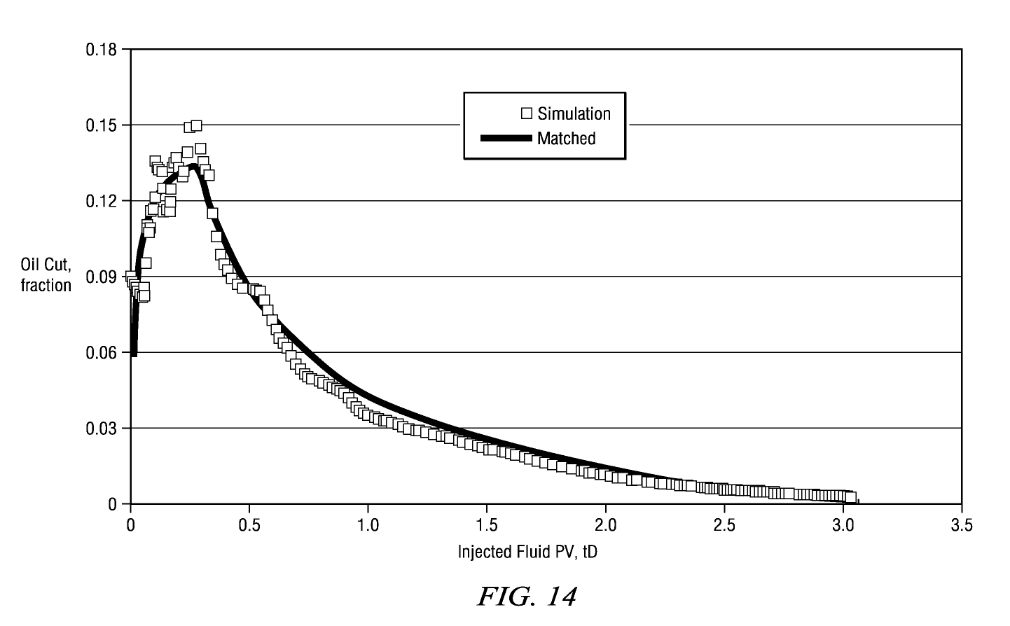

FIG. 14 illustrates a WAG numerical simulation history matching of simulation data and results predicted using the general advanced recovery forecasting model. In FIG. 14, the history match of WAG numerical simulation recovery efficiency results is shown for W_{R}=2.75, P=2125 psi, V_{DP}=0.8 and λ=5.25 using a general isothermal EOR forecasting model. As shown in FIG. 14, the advanced recovery forecasting model shows good agreement with simulation results. Chemical EOR numerical simulation history matching may also be done as strong as WAG.

To develop the forecasting tool for secondary recovery processes (e.g., waterflooding), a similar procedure of experimental design (on extensive range of recovery process/reservoir variable ranges of Table 4) and numerical simulations may also be performed using any suitable simulator (e.g., UTCHEM). The results of the waterflooding simulations may also be history matched using the forecasting model described above to correlate the variations of the forecasting model variables (water front Koval factor; K_{w} and final average oil saturation; S_{oF}) to process/reservoir variables (M^{o}, V_{DP} and λ). Waterflood simulation results may be history matched as well as EOR numerical simulations.

After history matching of all of the numerical simulations for each secondary/tertiary recovery process, a Response Surface Modeling (RSM) technique may be used to correlate the forecasting model variables (Koval factors and final average oil saturation) to process/reservoir variables. The arrays of Koval factor/s and S_{oF} from the history matching may be related to corresponding to process/reservoir variables for waterflooding and EOR processes. The RSM procedure includes multivariate non-linear regression analysis of the data using cubic model.

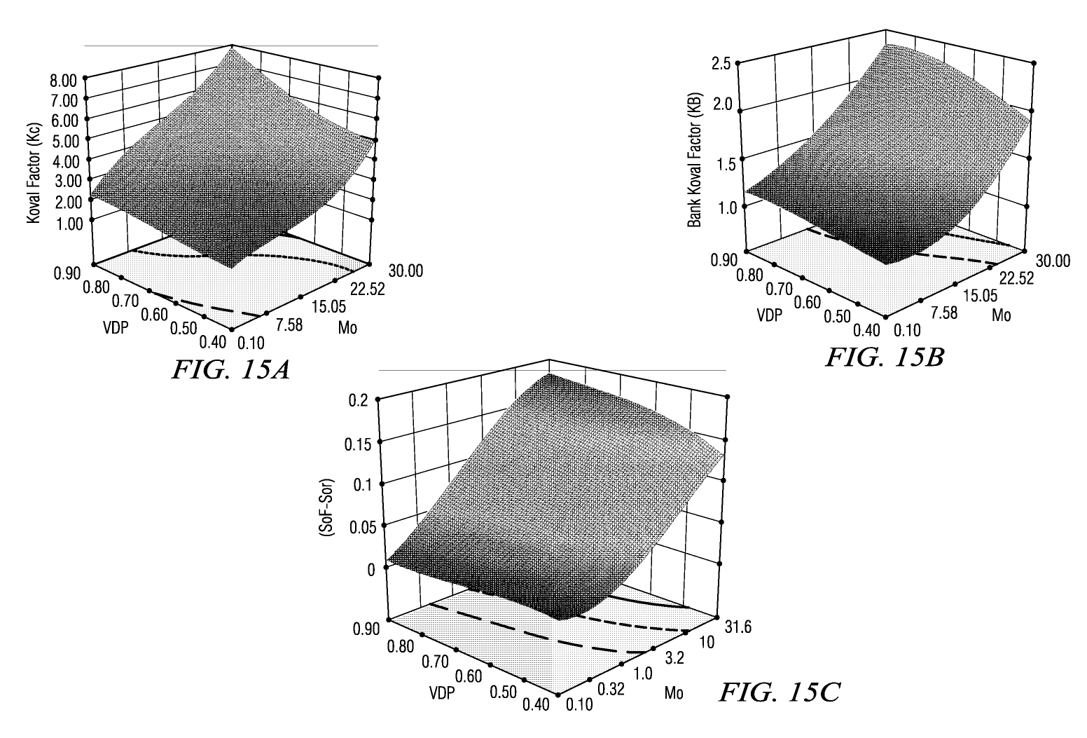

For example, in case of polymer flooding, K_{C}, K_{B} and S_{oF} as functions of M^{o}, λ and V_{DP} are modeled. The strength of the correlations (R² closer to 1) may indicate whether the forecasting model variables can reliably be used to represent the process/reservoir variables or not. In other words, the strength of the correlations may show the ability of the forecasting model for forecasting purposes of EOR results. FIGS. 15a, 15b and 15c show the correlations (response surfaces) describing the chemical (polymer) front Koval factor (K_{C}), oil bank front Koval factor (K_{B}) and final average oil saturation (S_{oF}), respectively, as functions of M^{o} and V_{DP} at constant λ. As shown in FIGS. 15a and 15b, variations in K_{B} may be substantially smaller than those in K_{C}, thus indicating that the oil bank front may be more stable than a displacing agent front. In the present example, λ=10. Table 6 summarizes the obtained correlation coefficient for each response surface.

As one can see, the R² values are very close to 1 (an R² value equal to one would indicate perfect agreement) thus indicating the correlations between the advanced recovery forecasting model variables (K_{C}, K_{B}, S_{oF}) and reservoir/process variables (Mₒ, λ and V_{DP}). In the present example, variations of K_{B} are much less than K_{C}. It varies between 1 and 3 and for most cases it is close to 1. Therefore, a variable called Effective Mobility Ratio (Koval factor) can couple the effect of the reservoir heterogeneity and mobility ratio and produce a more efficient and useful dimensionless group for prediction and analysis of secondary/tertiary recovery processes.

TABLE 7
Correlation coefficients (R²) for response surfaces of the general
isothermal EOR forecasting model (UTF) for polymer flooding

| Forecasting | |
|---|---|
| Model Variable | Correlation Coefficient (R²) |
| K_{C} | 0.9953 |
| K_{B} | 0.9913 |
| S_{oF} − Sₒᵣ | 0.9981 |

The mathematical equations describing the K_{C} and S_{oF} response surfaces are expressed in Equations 48 and 49, respectively:

$$\begin{matrix}{K}_{C} = 6.00761 - 0.036032 ( M° ) - 21.00500 ( {V}_{DP} ) + 0.84725 ( {λ}_{x} ) - 7.89447 \times {10}^{- 3} {( M° )}^{2} + 26.96217 {( {V}_{DP} )}^{2} - 0.14320 {( {λ}_{x} )}^{2} + 0.58763 ( M° ) ( {V}_{DP} ) - 7.96787 \times {10}^{- 3} ( M° ) ( {λ}_{x} ) - 0.22240 ( {V}_{DP} ) ( {λ}_{x} ) + 2.21500 \times {10}^{- 4} {( M° )}^{3} - 8.39313 {( {V}_{DP} )}^{3} + 2.53764 \times {10}^{- 3} {( {λ}_{x} )}^{3} - 7.00770 \times {10}^{- 3} {( M° )}^{2} ( {V}_{DP} ) + 4.39990 \times {10}^{- 4} {( M° )}^{2} ( {λ}_{x} ) + 0.29116 ( M° ) {( {V}_{DP} )}^{2} + 1.88430 \times {10}^{- 3} ( M° ) {( {λ}_{x} )}^{2} - 1.10267 {( {V}_{DP} )}^{2} ( {λ}_{x} ) + 0.15292 ( {V}_{DP} ) {( {λ}_{x} )}^{2} - 0.061770 ( M° ) ( {V}_{DP} ) ( {λ}_{x} ) & ( 48 ) \\ {S}_{oF} - {S}_{or} = 0.039817 + 0.038445 Log ( M° ) + 0.20441 ( {V}_{DP} ) - 0.010662 ( {λ}_{x} ) + 0.032582 {( Log ( M° ) )}^{2} - 0.54928 {( {V}_{DP} )}^{2} + 2.12965 \times {10}^{- 4} {( {λ}_{x} )}^{2} + 0.10987 Log ( M° ) ( {V}_{DP} ) - 5.03781 \times {10}^{- 3} Log ( M° ) ( {λ}_{x} ) + 0.042352 ( {V}_{DP} ) ( {λ}_{x} ) - 9.87510 \times {10}^{- 3} {( Log ( M° ) )}^{3} + 0.46141 {( {V}_{DP} )}^{3} - 1.07799 \times {10}^{- 4} {( {λ}_{x} )}^{3} - 0.048555 {( Log ( M° ) )}^{2} ( {V}_{DP} ) + 1.27602 \times {10}^{- 3} {( Log ( M° ) )}^{2} ( {λ}_{x} ) - 0.071890 Log ( M° ) {( {V}_{DP} )}^{2} + 7.81201 \times {10}^{- 5} Log ( M° ) {( {λ}_{x} )}^{2} - 0.044982 {( {V}_{DP} )}^{2} ( {λ}_{x} ) + 1.63135 \times {10}^{- 3} ( {V}_{DP} ) {( {λ}_{x} )}^{2} + 5.59919 \times {10}^{- 3} Log ( M° ) ( {V}_{DP} ) ( {λ}_{x} ) & ( 49 )\end{matrix}$$

where Sₒᵣ is residual oil saturation to the waterflood, which may be a simulator input.

These equations are of the form that illustrate different orders of interactions in the coefficients of different combination of variables (single terms, binary terms, etc.). For example, the sensitivity of K_{C} to V_{DP} is adjusted by 21.005. The equations also illustrate the so-called couplings or interactions of variables, which may indicate those incidents in which the combination of variables may be important. For example the combination of mobility ratio and V_{DP} has 0.58763 as its sensitivity, which is larger than the single-variable sensitivity to mobility ratio. The Koval factor and final average oil saturation capture these intercations (couplings) to more effectively analyze the recovery results.

A similar procedure of Response Surface Modeling and non-linear multivariate regression analysis may be performed on solvent (gas) flooding/WAG EOR and waterflooding history matching results. The results may also indicate strong correlations for solvent flooding/WAG and waterflooding similarly as for chemical EOR discussed above. Tables 8 and 9 show the obtained correlation coefficients for each forecasting model variable (Koval factor/s and S_{oF}) of the present example. As the tables show, the correlation coefficients are very close to 1, in the present example, thus, supporting the reliability of the advanced recovery forecasting model for forecasting of advanced recovery results.

TABLE 8
Correlation coefficients (R²) for response surfaces of the general
isothermal advanced recovery forecasting model in solvent flooding/WAG

| Forecasting | |
|---|---|
| Model Variable | Correlation Coefficient (R²) |
| K_{S} | 0.9989 |
| K_{B} | 0.9977 |
| S_{oF} | 0.9986 |

TABLE 9
Correlation coefficients (R²) for response surfaces of the general
isothermal advanced recovery forecasting model in waterflooding

| Forecasting | |
|---|---|
| Model Variable | Correlation Coefficient (R²) |
| K_{W} | 0.9961 |
| S_{oF} − Sₒᵣ | 0.9925 |

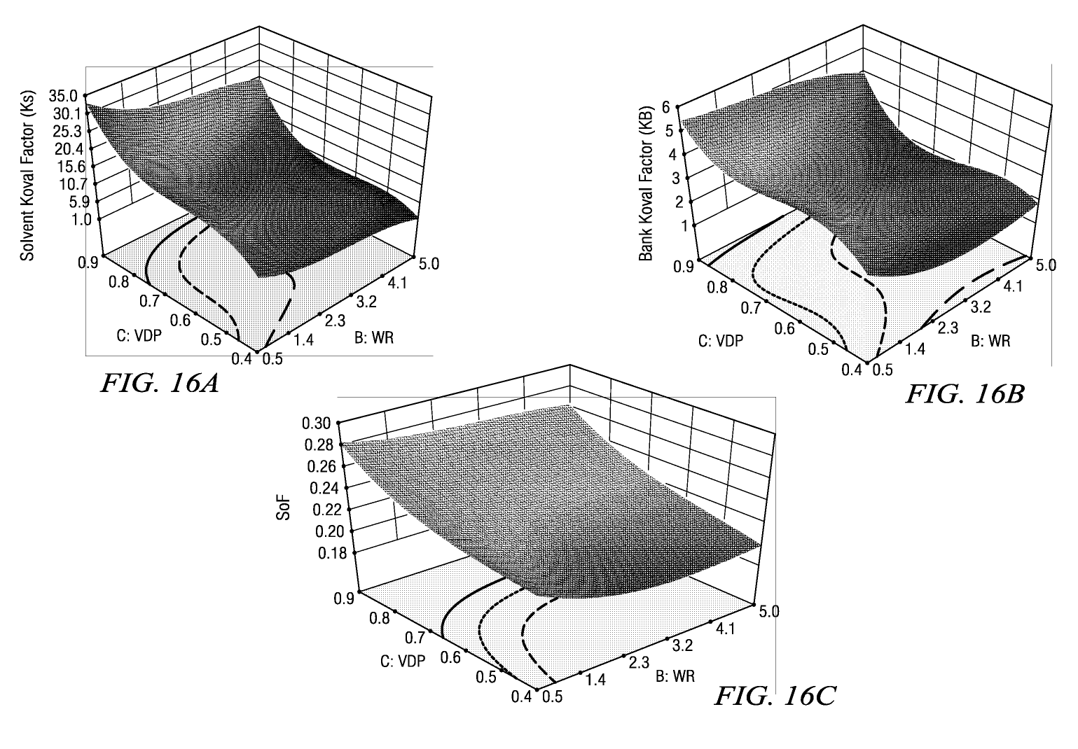

FIGS. 16a, 16b and 16c illustrate the correlations (response surfaces) of the solvent front Koval factor (K_{S}), oil bank front Koval factor (K_{B}) and final average oil saturation (S_{oF}), respectively, as functions of W_{R} (WAG ratio) and V_{DP} (Dykstra-Parsons coefficient) at constant λ (dimensionless correlation length) and pressure. In the present example, λ=10 and BHP=2800 psi. The mathematical equations describing correlations (response surfaces) of K_{S} and S_{oF} are given in equations 50 and 51, respectively.

$$\begin{matrix}{K}_{S} = - 61.07430 - 48.59713 ( Δ {P}_{D} ) - 8.16085 ( {W}_{R} ) + 475.83772 ( {V}_{DP} ) - 3.88420 ( {λ}_{x} ) + 9.37539 ( Δ {P}_{D} ) ( {W}_{R} ) + 56.03240 ( Δ {P}_{D} ) ( {V}_{DP} ) - 2.80602 ( Δ {P}_{D} ) ( {λ}_{x} ) - 17.66087 ( {W}_{R} ) ( {V}_{DP} ) + 0.43156 ( {W}_{R} ) ( {λ}_{x} ) + 17.94027 ( {V}_{DP} ) ( {λ}_{x} ) + 98.11462 {( Δ {P}_{D} )}^{2} + 3.18925 {( {W}_{R} )}^{2} - 887.98935 {( {V}_{DP} )}^{2} - 0.23176 {( {λ}_{x} )}^{2} - 0.57408 ( Δ {P}_{D} ) ( {W}_{R} ) ( {V}_{DP} ) + 0.18552 ( Δ {P}_{D} ) ( {W}_{R} ) ( {λ}_{x} ) + 2.19911 ( Δ {P}_{D} ) ( {V}_{DP} ) ( {λ}_{x} ) - 0.078609 ( {W}_{R} ) ( {V}_{DP} ) ( {λ}_{x} ) - 0.76257 {( Δ {P}_{D} )}^{2} ( {W}_{R} ) - 83.59955 {( Δ {P}_{D} )}^{2} ( {V}_{DP} ) + 3.23717 {( Δ {P}_{D} )}^{2} ( {λ}_{x} ) - 1.27811 ( Δ {P}_{D} ) {( {W}_{R} )}^{2} - 24.53074 ( Δ {P}_{D} ) {( {V}_{DP} )}^{2} - 0.11428 ( Δ {P}_{D} ) {( {λ}_{x} )}^{2} + 0.74740 {( {W}_{R} )}^{2} ( {V}_{DP} ) - 0.042527 {( {W}_{R} )}^{2} ( {λ}_{x} ) + 10.11483 ( {W}_{R} ) {( {V}_{DP} )}^{2} - 0.022650 ( {W}_{R} ) {( {λ}_{x} )}^{2} - 18.97506 {( {V}_{DP} )}^{2} ( {λ}_{x} ) + 0.11332 ( {V}_{DP} ) {( {λ}_{x} )}^{2} - 62.71628 {( Δ {P}_{D} )}^{3} - 0.30201 {( {W}_{R} )}^{3} + 582.25048 {( {V}_{DP} )}^{3} + 0.018055 {( {λ}_{x} )}^{3} & ( 50 ) \\ {S}_{oF} = + 0.20012 - 0.025570 ( Δ {P}_{D} ) - 0.037532 ( {W}_{R} ) + 0.23188 ( {V}_{DP} ) + 4.53543 E - 003 ( {λ}_{x} ) + 1.93914 \times {10}^{- 3} ( Δ {P}_{D} ) ( {W}_{R} ) - 0.097652 ( Δ {P}_{D} ) ( {V}_{DP} ) + 2.70964 \times {10}^{- 3} ( Δ {P}_{D} ) ( {λ}_{x} ) + 0.048883 ( {W}_{R} ) ( {V}_{DP} ) - 1.68578 \times {10}^{- 3} ( {W}_{R} ) ( {λ}_{x} ) + 6.42492 \times {10}^{- 3} ( {V}_{DP} ) ( {λ}_{x} ) + 8.98656 \times {10}^{- 4} {( Δ {P}_{D} )}^{2} + 7.24988 \times {10}^{- 3} {( {W}_{R} )}^{2} - 0.48553 {( {V}_{DP} )}^{2} - 1.11119 \times {10}^{- 3} {( {λ}_{x} )}^{2} - 3.68059 \times {10}^{- 3} ( Δ {P}_{D} ) ( {W}_{R} ) ( {V}_{DP} ) + 1.69708 \times {10}^{- 4} ( Δ {P}_{D} ) ( {W}_{R} ) ( {λ}_{x} ) - 8.84339 \times {10}^{- 3} ( Δ {P}_{D} ) ( {V}_{DP} ) ( {λ}_{x} ) + 4.79314 \times {10}^{- 4} ( {W}_{R} ) ( {V}_{DP} ) ( {λ}_{x} ) - 2.36617 \times {10}^{- 3} {( Δ {P}_{D} )}^{2} ( {W}_{R} ) - 0.11140 {( Δ {P}_{D} )}^{2} ( {V}_{DP} ) + 1.92949 \times {10}^{- 3} {( Δ {P}_{D} )}^{2} ( {λ}_{x} ) + 3.57839 \times {10}^{- 4} ( Δ {P}_{D} ) {( {W}_{R} )}^{2} + 0.22762 ( Δ {P}_{D} ) {( {V}_{DP} )}^{2} - 1.58887 \times {10}^{- 5} ( Δ {P}_{D} ) {( {λ}_{x} )}^{2} - 5.49910 \times {10}^{- 3} {( {W}_{R} )}^{2} ( {V}_{DP} ) + 1.68304 \times {10}^{- 4} {( {W}_{R} )}^{2} ( {λ}_{x} ) - 0.014068 ( {W}_{R} ) {( {V}_{DP} )}^{2} + 2.66040 \times {10}^{- 5} ( {W}_{R} ) {( {λ}_{x} )}^{2} - 9.90097 \times {10}^{- 3} {( {V}_{DP} )}^{2} ( {λ}_{x} ) + 1.88536 \times {10}^{- 4} ( {V}_{DP} ) {( {λ}_{x} )}^{2} + 0.073288 {( Δ {P}_{D} )}^{3} - 4.34448 \times {10}^{- 4} {( {W}_{R} )}^{3} + 0.38523 {( {V}_{DP} )}^{3} + 6.34764 \times {10}^{- 5} {( {λ}_{x} )}^{3} & ( 51 )\end{matrix}$$

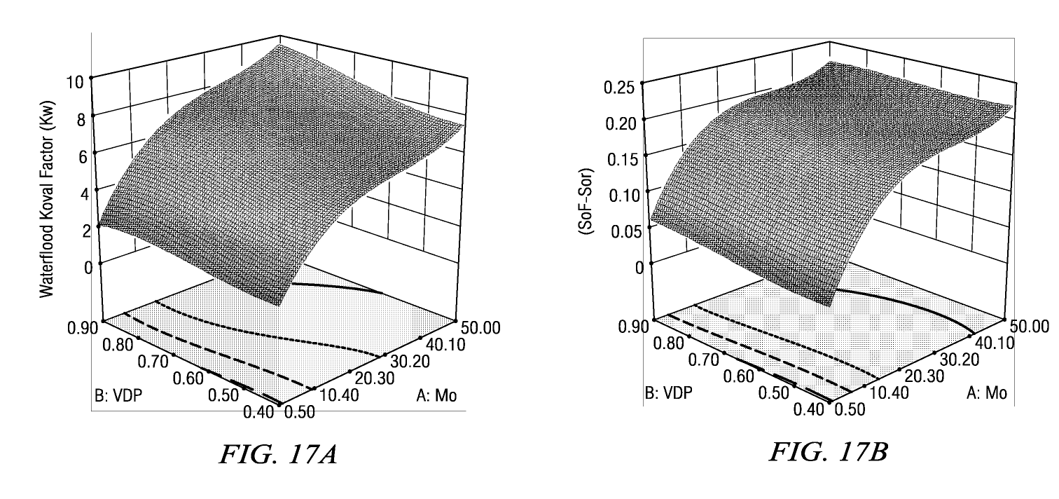

FIGS. 17a and 17b show the correlations (response surfaces) of the water front Koval factor (K_{W}) and final average oil saturation (S_{oF}), respectively, as functions of M^{o} and V_{DP} at constant λ (dimensionless correlation length), according to an example of the present disclosure. In the present example, λ=10. The mathematical equations describing these correlations (K_{W} and S_{oF} surfaces) are described in equations 52 and 53, respectively.

$$\begin{matrix}{K}_{W} = 8.52049 + 0.63214 ( M° ) - 35.73891 ( {V}_{DP} ) - 0.24703 ( {λ}_{x} ) - 0.010454 {( M° )}^{2} + 56.16179 {( {V}_{DP} )}^{2} - 0.403542 \times {10}^{- 3} {( {λ}_{x} )}^{2} + 0.058956 ( M° ) ( {V}_{DP} ) - 2.81600 \times {10}^{- 3} ( M° ) ( {λ}_{x} ) + 1.04064 ( {V}_{DP} ) ( {λ}_{x} ) + 1.02571 \times {10}^{- 4} {( M° )}^{3} - 25.81984 {( {V}_{DP} )}^{3} + 5.38014 \times {10}^{- 4} {( {λ}_{x} )}^{3} - 1.26106 \times {10}^{- 3} {( M° )}^{2} ( {V}_{DP} ) + 1.10920 \times {10}^{- 4} {( M° )}^{2} ( {λ}_{x} ) + 0.12849 ( M° ) {( {V}_{DP} )}^{2} + 1.84360 \times {10}^{- 4} ( M° ) {( {λ}_{x} )}^{2} - 0.89478 {( {V}_{DP} )}^{2} ( {λ}_{x} ) - 0.0010023 ( {V}_{DP} ) {( {λ}_{x} )}^{2} - 0.010158 ( M° ) ( {V}_{DP} ) ( {λ}_{x} ) & ( 52 ) \\ {S}_{oF} - {S}_{or} = + 0.20163 + 0.012740 M° - 0.71847 ( {V}_{DP} ) - 0.012360 ( {λ}_{x} ) - 3.75107 \times {10}^{- 4} {( M° )}^{2} + 1.00174 {( {V}_{DP} )}^{2} + 9.58193 \times {10}^{- 4} {( {λ}_{x} )}^{2} + 6.52122 \times {10}^{- 4} ( M° ) ( {V}_{DP} ) + 4.75905 \times {10}^{- 6} ( M° ) ( {λ}_{x} ) + 0.026578 ( {V}_{DP} ) ( {λ}_{x} ) + 3.54335 \times {10}^{- 6} {( M° )}^{3} - 0.38533 {( {V}_{DP} )}^{3} - 5.18925 \times {10}^{- 5} {( {λ}_{x} )}^{3} + 1.04198 \times {10}^{- 5} {( M° )}^{2} ( {V}_{DP} ) + 1.36382 \times {10}^{- 6} {( M° )}^{2} ( {λ}_{x} ) - 4.04826 \times {10}^{- 4} ( M° ) {( {V}_{DP} )}^{2} + 3.29316 \times {10}^{- 6} ( M° ) {( {λ}_{x} )}^{2} - 0.021245 {( {V}_{DP} )}^{2} ( {λ}_{x} ) - 1.81146 \times {10}^{- 4} ( {V}_{DP} ) {( {λ}_{x} )}^{2} - 1.47984 \times {10}^{- 4} ( M° ) ( {V}_{DP} ) ( {λ}_{x} ) & ( 53 )\end{matrix}$$

The Koval-based approach described above combines vertical and areal sweep into a single factor, the Koval factor. It therefore may no longer be necessary to estimate these effects separately and then combine them. The displacement sweep from relative permeability measurements is retained but its complexity may be vastly reduced by treating the displacements as locally piston-like. The simplification from the Koval-based approach may be the replacement of a physical dimension, thickness, with a storage capacity. The flow-storage capacity curve (e.g., illustrated in FIG. 4a) may be parameterized with the Koval factor to account for heterogeneously porous reservoirs.

The forecasting model may substantially reproduce (R²>0.8) field and simulated data indicating that it may be used to forecast the performance of a plurality of secondary and/or tertiary recovery methods.

The matching of the model predictions with the data indicates that:
Koval factors may be arranged in order of increasing mobility ratio. The Koval factor for the oil banks may be the smallest, indicating that the oil banks may be more stable than that of the displacement agents;

The Koval factors and final average oil saturation may increase by increasing the mobility ratio and reservoir heterogeneity as characterized by the Dykstra-Parsons coefficient (V_{DP}), and the dimensionless geostatistical correlation length λₓ.
The Koval factors determined based on field and pilot hole data may be smaller than that inferred from the statistics of core permeability measurements;
The differences in Koval factors indicates that the final average oil saturation may be larger, sometimes much larger, than what is observed in laboratory experiments. This observation suggests that a feature of field displacements may be the existence of a missing or lost pore volume, a volume that may not be accessed by displacement agents; and
History matching of numerical simulation may show strong correlations between the forecasting model variables and reservoir/recovery process variables (e.g., Koval factors and final average oil saturation), which may form the basis for the forecasting tool.

Accordingly, based on the present disclosure a general isothermal advanced recovery forecasting tool may be developed that accurately matches the results of a plurality of types of isothermal advanced recovery processes. The general advanced recovery forecasting model may determine and use the Koval factor (effective mobility ratio) of the displacement agent to effectively couple the effects of reservoir heterogeneity (as measured by V_{DP} and λₓ) to determine the recovery results. The use of the Koval factor may create a more efficient and useful dimensionless variable for predicting and analyzing advanced recovery method results. Additionally, the Koval factor and final average oil saturation may indicate oil recovery by indicating that an increased mobility ratio and reservoir heterogeneity (as indicated by a higher Koval factor and final average oil saturation) may reduce oil recovery. Therefore, the smaller the Koval factor, the more stable the advanced recovery flood may be, which may yield a higher recovery.

Based on these principles, the advanced recovery forecasting model may be used to compare and analyze different advanced recovery processes for a reservoir. For example, the model may indicate that in water and polymer flooding, mobility ratio may be an influential reservoir/EOR process variable that governs the oil recovery efficiency. A favorable mobility ratio (M^{o} less than 3) can substantially compensate for the unfavorable effects of the reservoir heterogeneity. Further, the model may indicate that in solvent (gas) flooding/WAG, reservoir heterogeneity may be a sensitive governing variable that affects the EOR recovery and sweep efficiency. The unfavorable effect of reservoir heterogeneity may worsen substantially for V_{DP} values about or greater than 0.8 such that decreasing WAG ratio (increasing gas injection) may not compensate for that.

The model of the present disclosure may also indicate that the use of foam with gas in a WAG EOR process may be advantageous for highly heterogeneous reservoir (V_{DP} about or greater than 0.8) to improve the sweep efficiency. Further, the model indicates that from reservoir engineering viewpoint, the Koval factor (the Effective Mobility Ratio) may effectively represent the coupling effects of the reservoir heterogeneity (V_{DP} and λ) with mobility of the phases (mobility ratio for chemical EOR, WAG ratio and pressure for solvent/WAG process EOR) for more effective analysis of recovery results. In contrast, the conventional (local) mobility ratio may be unable to represent the effects of the reservoir heterogeneity. Moreover, the model may indicate that, generally, the higher the Koval factor the less the recovery efficiency and vice versa. The Koval factor may be increased by increasing the reservoir heterogeneity and mobility ratio of the phases.

Therefore, the general advanced recovery forecasting model of the present disclosure may be implemented in a simulation tool to predict the performances of various advanced recovery methods for a given reservoir. As described above, the general advanced recovery forecasting model may be configured to use factors such as a Dykstra-Parsons coefficient (V_{DP}), a mobility ratio of the displacement agent and oil (M^{o}) and an autocorrelation length (λ) to determine Koval factors and final average oil saturation to determine average oil saturation of a reservoir as a function of time. As such, a comparison between the performances of each simulated recovery method may be made to determine which method may be most suitable for the given reservoir. By using the same model for each method, the differences in performance may be attributed to the differences in the method themselves. As described above, in alternative embodiments, as described above the Koval factors and final average oil saturation may be determined using actual field data and history matching. The average oil saturation of the reservoir as a function of time may be determined accordingly.

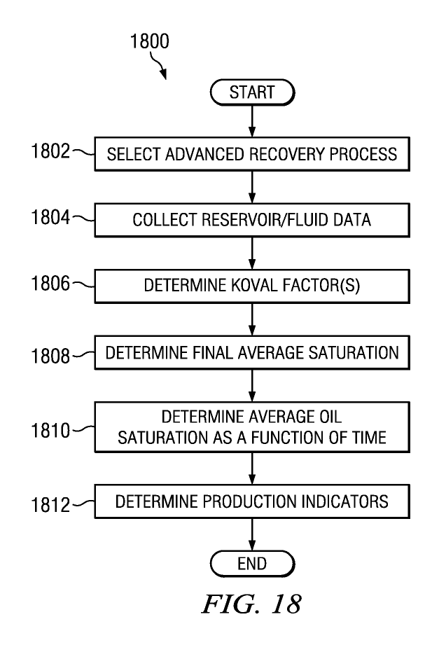

FIG. 18 illustrates a flow chart of an example method 1800 for forecasting the results of an advanced recovery process in accordance with some embodiments of the present disclosure. The steps of method 1800 may be performed by any suitable, system, apparatus, or device. For example, method 1800 may be performed by a processor configured to execute instructions embodied in one or more computer readable media communicatively coupled to the processor. The instructions may be associated with performance of one or more steps of method 1800.

Method 1800 may start and at step 1802 an advanced recovery process (e.g., water flood, chemical EOR, WAG) may be selected for a reservoir for determining forecasted production of the reservoir using the selected advanced recovery process. At step 1804, reservoir and fluid data may be collected by the advanced recovery forecasting model based on the reservoir and selected advanced recovery process. For example, the initial oil saturation of the reservoir (Sₒᵢ), the saturation of the reservoir remaining after a conventional recovery process has been used, but before the selected advanced recovery process has been implemented (S_{oR}), and an ideal residual oil saturation of the reservoir after the selected advanced recovery process has finished (Sₒᵣ) may be collected. Additionally, pore volume of the reservoir may be collected, along with heterogeneity and geostatistical data (e.g., V_{DP} and λₓ). Further the mobility ratio of the displacement agent associated with the selected advanced recovery method may be collected.

At step 1806, one or more Koval factors may be determined for the selected advanced recovery process depending on which advanced recovery process is selected at step 1802. For example, if a secondary advanced recovery process (e.g., waterflooding) is selected a Koval factor for the secondary advanced recovery displacement agent (e.g., water) may be determined. If a tertiary advanced recovery process, a Koval factor for the advanced recovery displacement agent may be determined along with a Koval factor for the oil of an oil bank zone. As described above, in some embodiments a Koval factor may be determined based on a Dykstra-Parsons coefficient (V_{DP}) of reservoir heterogeneity, a mobility ratio (M^{o}) of the respective fluids in the reservoir, and an autocorrelation length (λ). In alternative embodiments, a Koval factor may be determined based on a history matching approach described above.

At step 1808, a final average oil saturation of the reservoir (S_{oF}) may be determined. Similarly to the Koval factor(s), the final average oil saturation may be determined based on a Dykstra-Parsons coefficient (V_{DP}) of reservoir heterogeneity, a mobility ratio (M^{o}) of the respective fluids in the reservoir, and an autocorrelation length (λ), as detailed above. In alternative embodiments, the final average oil saturation may be determined using a history matching approach described above.

At step 1810, using the determined Koval factor(s) and final average oil saturation, the overall average oil saturation of a reservoir as a function of time with respect to the selected advanced recovery process may be determined, as described above with respect to FIGS. 4a-5. At step 1812, any number of other oil production indicators may be determined based on the average oil saturation of the reservoir as a function of time for the selected advanced recovery process. For example, the volumetric sweep, recovery efficiency, oil cut, oil rate, cumulative oil recovery and oil bank displacing fluid regions may be calculated as a function of time based on the average oil saturation of the reservoir as a function of time. Each of the oil production indicators (including the overall average oil saturation as a function of time) may indicate the efficacy of the advanced recovery process being modeled. Following step 1812, method 1800 may end.

Method 1800 may be repeated for any number of suitable isothermal advanced recovery processes to determine different average oil saturations as a function of time associated with the different advanced recovery processes. The different average oil saturations may be compared against each other to determine which advanced recovery process may provide the best production for the given reservoir.

Modifications, additions, or omissions may be made to method 1800 without departing from the scope of the present disclosure. For example, if a tertiary advanced recovery process is selected, an oil saturation of the associated oil bank (S_{oB}) may be determined using a fractional flow diagram or history matching, as described above. Further, the order of the steps may be varied without departing from the scope of the present disclosure.

Although the present disclosure and its advantages have been described in detail, various changes, substitutions and alterations can be made herein without departing from the spirit and scope of the disclosure. For example, specific examples have been given to illustrate the performance and functionality of the advanced recovery forecasting model, however it is understood that the model may be used for any suitable analysis of any suitable reservoir and/or recovery method. Numerous other changes, substitutions, variations, alterations and modifications may be ascertained by those skilled in the art and it is intended that particular embodiments encompass all such changes, substitutions, variations, alterations and modifications as falling within the spirit and scope of the appended claims.

What is claimed is:

1. A method for forecasting an advanced recovery process for a reservoir comprising:
determining a displacement Koval factor associated with a displacement agent associated with an advanced recovery process, the displacement Koval factor based on heterogeneity of porosity the reservoir and mobility of the displacement agent;
determining a final average oil saturation of the reservoir associated with the advanced recovery process being finished; and
determining an average oil saturation of the reservoir as a function of time for the advanced recovery process based on the displacement Koval factor and the final average oil saturation.

2. The method of claim 1, wherein the displacement agent comprises at least one of water, a gas, a polymer, and an alkaline surfactant polymer.

3. The method of claim 1, further comprising determining the displacement Koval factor based on at least one of a distribution of permeability of the reservoir, a mobility ratio between the displacement agent and oil associated with the reservoir, and an arrangement of heterogeneity of porosity of the reservoir.

4. The method of claim 1, further comprising determining the final average oil saturation based on at least one of a distribution of permeability of the reservoir, a mobility ratio between the displacement agent and oil associated with the reservoir, and an arrangement of heterogeneity of porosity of the reservoir.

5. The method of claim 1, further comprising determining the displacement Koval factor based on field data associated with a substantially analogous reservoir and a substantially analogous advanced recovery process.

6. The method of claim 1, further comprising determining the final average oil saturation based on field data associated with a substantially analogous reservoir and a substantially analogous advanced recovery process.

7. The method of claim 1, further comprising:
determining an oil bank Koval factor associated an oil bank zone of the reservoir, the oil bank Koval factor based on heterogeneity of porosity of the reservoir and mobility of the oil within the oil bank zone; and
determining the average oil saturation of the reservoir as a function of time for the advanced recovery process based on the oil bank Koval factor, displacement Koval factor and the final average oil saturation of the reservoir.

8. The method of claim 7, further comprising determining the oil bank Koval factor based on at least one of a distribution of permeability of the reservoir, a mobility ratio between the displacement agent and oil associated with the reservoir, and an arrangement of heterogeneity of porosity of the reservoir.

9. The method of claim 7, further comprising determining the oil bank Koval factor based on field data associated with a substantially analogous reservoir and a substantially analogous advanced recovery process.

10. The method of claim 1, further comprising determining, based on the average oil saturation of the reservoir as a function of time, at least one of volumetric sweep, recovery efficiency, oil cut, oil rate, and cumulative oil recovery as a function of time.

11. One or more non-transitory computer-readable media embodying logic that, when executed by a processor, is configured to perform operations comprising:
determining a displacement Koval factor associated with a displacement agent associated with an advanced recovery process, the displacement Koval factor based on heterogeneity of porosity of the reservoir and mobility of the displacement agent;
determining a final average oil saturation of the reservoir associated with the advanced recovery process being finished; and
determining an average oil saturation of the reservoir as a function of time for the advanced recovery process based on the displacement Koval factor and the final average oil saturation.

12. The one or more media of claim 11, wherein the displacement agent comprises at least one of water, a gas, a polymer, and an alkaline surfactant polymer.

13. The one or more media of claim 11, wherein the logic is further configured to perform operations comprising determining the displacement Koval factor based on at least one of a distribution of permeability of the reservoir, a mobility ratio between the displacement agent and oil associated with the reservoir, and an arrangement of heterogeneity of porosity of the reservoir.

14. The one or more media of claim 11, wherein the logic is further configured to perform operations comprising determining the final average oil saturation based on at least one of a distribution of permeability of the reservoir, a mobility ratio between the displacement agent and oil associated with the reservoir, and an arrangement of heterogeneity of porosity of the reservoir.

15. The one or more media of claim 11, wherein the logic is further configured to perform operations comprising determining the displacement Koval factor based on field data associated with a substantially analogous reservoir and a substantially analogous advanced recovery process.

16. The one or more media of claim 11, wherein the logic is further configured to perform operations comprising determining the final average oil saturation based on field data associated with a substantially analogous reservoir and a substantially analogous advanced recovery process.

17. The one or more media of claim 11, wherein the logic is further configured to perform operations comprising:
determining an oil bank Koval factor associated an oil bank zone of the reservoir, the oil bank Koval factor based on heterogeneity of porosity of the reservoir and mobility of the oil within the oil bank zone; and
determining the average oil saturation of the reservoir as a function of time for the advanced recovery process based on the oil bank Koval factor, displacement Koval factor and the final average oil saturation of the reservoir.

18. The one or more media of claim 17, wherein the logic is further configured to perform operations comprising determining the oil bank Koval factor based on at least one of a distribution of permeability of the reservoir, a mobility ratio between the displacement agent and oil associated with the reservoir, and an arrangement of heterogeneity of porosity of the reservoir.

19. The one or more media of claim 17, wherein the logic is further configured to perform operations comprising determining the oil bank Koval factor based on field data associated with a substantially analogous reservoir and a substantially analogous advanced recovery process.

20. The one or more media of claim 11, wherein the logic is further configured to perform operations comprising determining, based on the average oil saturation of the reservoir as a function of time, at least one of volumetric sweep, recovery efficiency, oil cut, oil rate, and cumulative oil recovery as a function of time.
